(19) United States
(12) Patent Application Publication
(10) Pub. No.: US 2021/0278293 A1
(43) Pub. Date: Sep. 9, 2021

(54) SENSOR, INPUT APPARATUS, AND ELECTRONIC DEVICE

(71) Applicant: Sony Corporation, Tokyo (JP)

(72) Inventors: Keisuke KINOKUNI, Tokyo (JP); Makoto YAMAGUCHI, Tokyo (JP); Hiroaki YAMANA, Tokyo (JP); Masakazu KOBAYASHI, Tokyo (JP); Ryo SHIRAIWA, Tokyo (JP)

(21) Appl. No.: 17/256,534

(22) PCT Filed: Jun. 28, 2019
(86) PCT No.: PCT/JP2019/025934

§ 371 Date: Dec. 28, 2020

(30) Foreign Application Priority Data
Jun. 28, 2018 (JP) 2018-123767

(51) Int. Cl. G01L 1/14; G06F 3/044; G06F 3/041

(52) U.S. Cl. CPC G01L 1/142; G06F 3/0414; G06F 3/044

(57) ABSTRACT

A sensor includes a base material, a first elastic layer provided on the base material, and a sensor body which is provided on the first elastic layer and includes an electrostatic capacitive sensing part, and the base material and the first elastic layer are bonded such that an area corresponding to the sensing part becomes a non-bonded area.

### TECHNICAL FIELD

The present disclosure relates to a sensor, an input apparatus, and an electronic device.

### BACKGROUND ART

In recent years, electronic devices capable of detecting pressing on a surface of a housing have been proposed. As one such electronic device, for example, PTL 1 proposes a device including a film-shaped sensor on an inner surface of a housing.

### CITATION LIST

### Patent Literature

### [PTL 1]

WO 2016/143241

### SUMMARY

### Technical Problem

Since a housing of an electronic device generally has high rigidity, a displacement amount thereof at the time of pressing is very small, and deformation thereof at the time of pressing occurs in a broad region. Therefore, a pressure on a surface of the housing is difficult for a sensor to detect. Further, the same problem may occur when detection of a pressure on a surface of a highly rigid exterior body other than a housing of an electronic device is attempted using a sensor.

An object of the present disclosure is to provide a sensor, an input apparatus, and an electronic device with which pressing on an exterior body such as a housing which has high rigidity can be detected.

### Solution to Problem

To solve the above problems, a first disclosure is a sensor including a base material, a first elastic layer provided on the base material, and a sensor body which is provided on the first elastic layer and includes an electrostatic capacitive sensing part, in which the base material and the first elastic layer are bonded such that an area corresponding to the sensing part becomes a non-bonded area.

A second disclosure is a sensor including a structure, a spring member provided on the structure, a support layer provided on the spring member, and a sensor body which is provided on the support layer and includes an electrostatic capacitive sensing part, in which the structure is provided at a position corresponding to the sensing part, and the support layer has a space at the position corresponding to the sensing part.

A third disclosure is an input apparatus including an exterior body and the sensor according to the first or second disclosure, in which the sensor is provided on an inner surface of the exterior body.

A fourth disclosure is an electronic device including a housing and the sensor according to the first or second disclosure, in which the sensor is provided on an inner surface of the housing.

### Advantageous Effects of Invention

According to the present disclosure, it is possible to detect pressing on an exterior body, such as a housing, having high rigidity. Also, the effects described herein are not necessarily limiting and any of the effects described in the present disclosure or different effects may be obtained.

### BRIEF DESCRIPTION OF DRAWINGS

FIG. 1A is a cross-sectional view showing an example of a configuration of a sensor for detecting pressing on a surface of a housing. FIG. 1B is a cross-sectional view showing an example of a state of the sensor when a surface of the sensor is pressed. FIG. 1C is a cross-sectional view showing an example of a state of the housing and the sensor when the surface of the housing is pressed.

FIG. 2 is an exploded perspective view showing an example of a configuration of an electronic device according to a first embodiment.

FIG. 3 is an enlarged plan view showing a part of a side wall part.

FIG. 4 is a cross-sectional view along line IV-IV in FIG. 3.

FIG. 5 is a perspective view showing an example of an exterior of the sensor.

FIG. 6A is a plan view showing an example of an arrangement of a plurality of sensing parts included in the sensor. FIG. 6B is a cross-sectional view showing an example of the configuration of the sensor.

FIG. 7 is a plan view showing an example of a configuration of the sensing part.

FIG. 8 is a cross-sectional view for explaining an example of a detecting operation when a button is pressed (when the surface of the housing is pressed).

FIG. 9 is a plan view showing a modified example of the sensing part.

FIG. 10A is a graph showing an example in which sensitivity dependence of the sensor on a width of a groove accommodating the sensor is high. FIG. 10B is a graph showing an example in which the sensitivity dependence of the sensor on the width of the groove accommodating the sensor is low.

FIG. 11 is a cross-sectional view showing an example of a configuration of a sensor according to a second embodiment.

FIG. 12 is a cross-sectional view showing an example of a configuration of a sensor according to a third embodiment.

FIG. 13 is a cross-sectional view showing an example of a configuration of a sensor according to a modified example of the third embodiment.

FIG. 14 is a cross-sectional view showing an example of a configuration of a sensor according to a fourth embodiment.

FIG. 15 is a cross-sectional view showing an example of a configuration of a sensor according to a fifth embodiment.

FIG. 16 is a cross-sectional view for explaining an example of a detecting operation when a button is pressed (when a surface of the housing is pressed).

FIG. 17 is a cross-sectional view showing an example of a configuration of a sensor according to a modified example of the fifth embodiment.

FIG. 18 is a cross-sectional view showing a state in which the sensor shown in FIG. 17 is bonded to an inner surface of the housing.

FIG. 19 is a cross-sectional view showing an example of a configuration of a sensor according to a modified example of the fifth embodiment.

FIG. 20 is a cross-sectional view showing an example of a configuration of a sensor according to a modified example of the fifth embodiment.

FIG. 21 is a perspective view showing a modified example of a supporting base material.

FIGS. 22A, 22B, 22C, and 22D are perspective views showing modified examples of a reference electrode layer.

FIG. 23A is a cross-sectional view showing an example of a configuration of a sensor according to a sixth embodiment. FIG. 23B is a development view showing the example of the configuration of the sensor according to the sixth embodiment.

FIG. 24A is a graph showing an evaluation result of displacement sensitivity of a sensor according to Example 1. FIG. 24B is a graph showing an evaluation result of displacement sensitivity of a sensor according to Example 2.

FIG. 25A is a graph showing an evaluation result of displacement sensitivity of a sensor according to Example 3. FIG. 25B is a graph showing an evaluation result of displacement sensitivity of a sensor according to Example 4.

FIG. 26A is a graph showing an evaluation result of displacement sensitivity of a sensor according to Example 5. FIG. 26B is a graph showing an evaluation result of displacement sensitivity of a sensor according to Example 6.

FIG. 27A is a graph showing an evaluation result of displacement sensitivity of a sensor according to Example 7. FIG. 27B is a graph showing an evaluation result of displacement sensitivity of a sensor according to Example 8.

FIG. 28A is a graph showing an evaluation result of displacement sensitivity of a sensor according Example 9 before an acceleration test. FIG. 28B is a graph showing an evaluation result of displacement sensitivity of the sensor according to Example 9 after the acceleration test.

FIG. 29A is a graph showing an evaluation result of displacement sensitivity of a sensor according to Example 10 before the acceleration test. FIG. 29B is a graph showing an evaluation result of displacement sensitivity of the sensor according to Example 10 after the acceleration test.

FIG. 30 is a graph showing an evaluation result of displacement sensitivity of a sensor according to Example 11.

FIG. 31 is a cross-sectional view showing a configuration of a simulation model of Test Example 2.

FIG. 32A is a graph showing simulation results of Test Example 1. FIG. 32B is a graph showing simulation results of Test Example 2.

FIG. 33 is a plan view showing a modified example of the sensing part.

FIG. 34 is a cross-sectional view showing an example of a configuration of a sensor according to a modified example of the first embodiment.

FIG. 35A is a plan view showing an example of a configuration of a sensor according to a modified example of the first embodiment. FIG. 35B is a side view of the sensor shown in FIG. 35A in a direction of arrow 20D.

### DESCRIPTION OF EMBODIMENTS

Embodiments of the present disclosure will be described in the following order. In addition, in all drawings of the following embodiments, the same or corresponding parts are denoted by the same reference numerals.

1 First embodiment (example of electronic device)

2 Second embodiment (example of sensor)

3 Third embodiment (example of sensor)

4 Fourth embodiment (example of sensor)

5 Fifth embodiment (example of sensor)

6 Sixth embodiment (example of sensor)

### 1 First Embodiment

### Overview

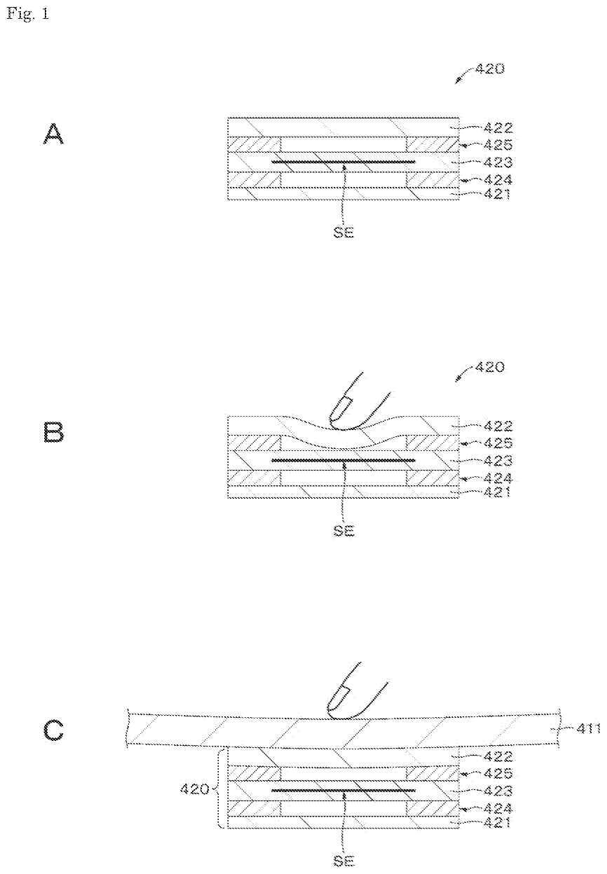

FIG. 1A shows an example of a configuration of a sensor 420 for detecting pressing on a surface of a housing. The sensor 420 includes a reference electrode layer (hereinafter referred to as a “REF layer”) 421, a REF layer 422 provided apart from the REF layer 421, a sensor electrode layer 423 which is provided between the REF layers 421 and 422 and includes an electrostatic capacitive sensing part SE, a support layer 424 provided between the REF layer 421 and the sensor electrode layer 423, and a support layer 425 provided between the REF layer 422 and the sensor electrode layer 423.

In the sensor 420, as shown in FIG. 1B, when a surface on the REF layer 422 side is pressed, the REF layer 422 is deformed toward the sensing part, and the REF layer 422 approaches the sensing part SE. This approach changes an electrostatic capacitance of the sensing part SE. On the basis of this change in electrostatic capacitance, a controller integrated circuit (IC) (not shown) detects the pressing on the sensor 420.

However, as shown in FIG. 1C, when the sensor 420 is provided on an inner surface of a housing, a displacement amount of the surface of the housing at the time of pressing is very small, and the deformation at the time of pressing occurs in a broad region. Therefore, it is difficult to detect the pressing on the surface of the housing using the sensor 420.

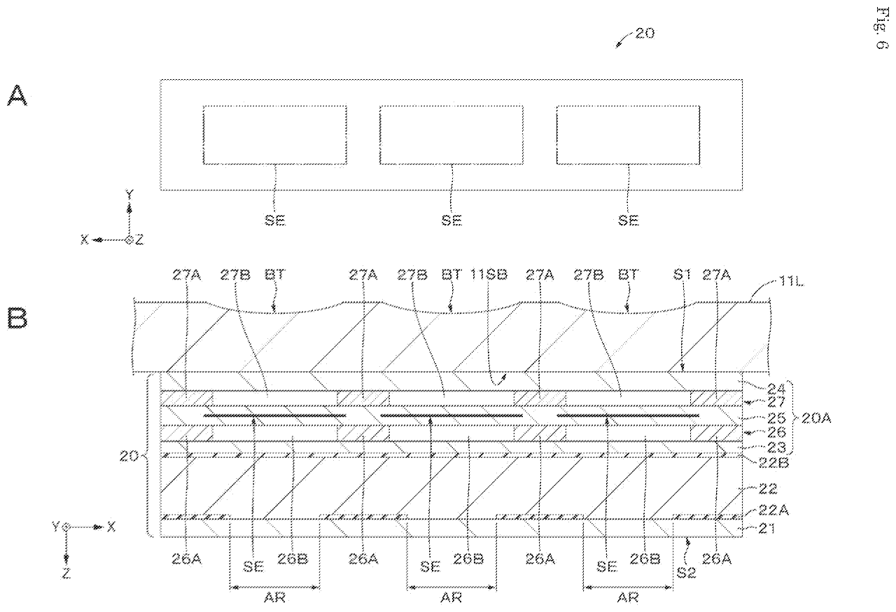

Therefore, the present inventors have diligently studied a sensor which can detect pressing on the surface of the housing. As a result, the present inventors have managed to devise a sensor 20 including, as shown in FIG. 6B, a support base material 21, an elastic layer 22 provided on the support base material 21, and a sensor body 20A which is provided on the elastic layer 22 and includes electrostatic capacitive sensing parts SE, in which the support base material 21 and the elastic layer 22 are bonded such that areas corresponding to the sensing parts SE become non-bonded areas AR. Hereinafter, an electronic device including the sensor 20 having such a configuration will be described.

[Configuration of Electronic Device]

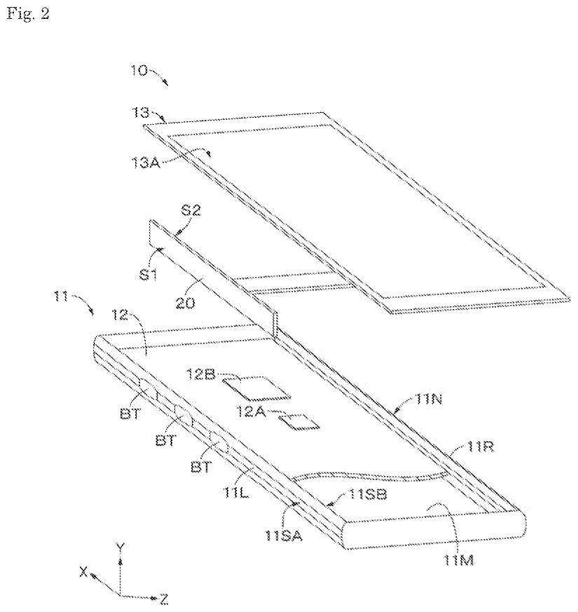

FIG. 2 shows an example of a configuration of an electronic device 10 according to a first embodiment. The electronic device 10 is a so-called smartphone and includes a housing 11 having a thin box shape with one principal surface open, a board 12 accommodated in the housing 11, a sensor 20 provided on an inner surface 11SB of the housing 11, and a front panel 13 provided to block the one principal surface that is open. In addition, an input apparatus includes the housing 11 and the sensor 20.

(Housing)

The housing 11 is an example of an exterior body and includes a rectangular plate-shaped bottom part 11M constituting a back surface of the electronic device 10 and a wall part 11N provided on a circumferential edge of the bottom part 11M. The wall part 11N stands perpendicular to the bottom part 11M and has side wall parts 11R and 11L provided on both long side sides of the bottom part 11M.

An outer surface 11SA of the side wall part 11L has a plurality of buttons BT provided to be arranged in a row in a longitudinal direction of the side wall part 11L (that is, a circumferential direction of the wall part 11N). The plurality of buttons BT are pseudo buttons, and recesses are provided at positions of the plurality of buttons BT. The plurality of buttons BT are, for example, a volume down button, a volume up button, a power button, and the like.

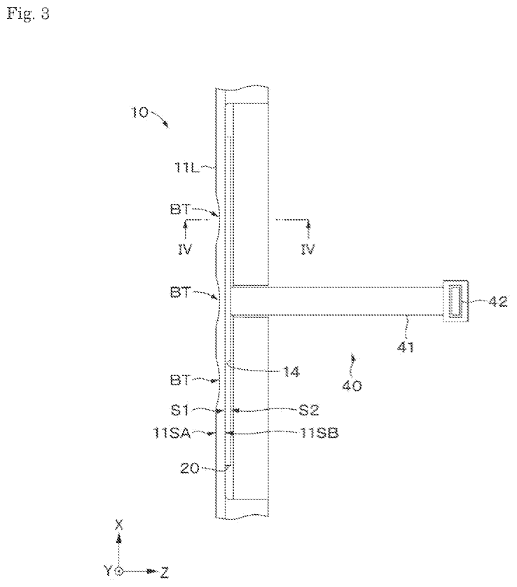

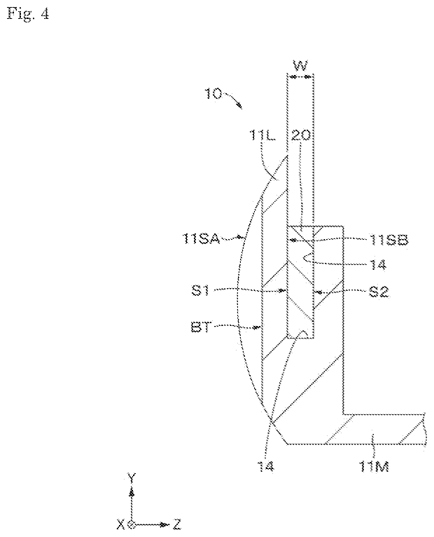

As shown in FIGS. 3 and 4, the housing 11 has a groove part 14 provided along the inner surface 11SB of the side wall part 11L. The sensor 20 is accommodated in the groove part 14. Also, in the present specification, a longitudinal direction of the sensor 20 is referred to as a ±X axis direction, a width direction (a lateral direction) thereof is referred to as a ±Y axis direction, and a direction perpendicular to the longitudinal direction and the width direction (that is, a direction perpendicular to a first surface S1 of the sensor 20) is referred to as a ±Z axis direction.

(Sensor)

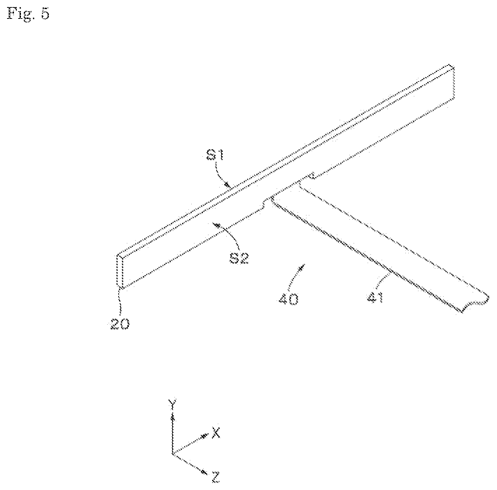

The sensor 20 is an electrostatic capacitive pressure sensitive sensor. In the first embodiment, a mutual capacitive pressure sensor is used as the electrostatic capacitive pressure sensor. As shown in FIG. 5, the sensor 20 has an elongated rectangular film shape, and a connection part 41 extends from a center of one long side of the sensor 20. A connector 42 is provided at a tip of the extending connection part 41, and this connector 42 is connected to a connector (not shown) provided on the board 12. The sensor 20 is configured to be able to detect pressing on the first surface S1 and is accommodated in the groove part 14 such that the first surface S1 is pressed against the inner surface 11SB. Also, in the present disclosure, the film should be considered to include a sheet as well. In addition, a shape of the sensor 20 is not limited to the film shape and may be a plate shape or the like.

The sensor 20 and the connection part 41 are integrally formed of one flexible printed circuit (hereinafter referred to as “FPC”) 40 having a T shape. By adopting such a configuration, the number of parts can be reduced. Further, impact durability of the connection between the sensor 20 and the board 12 can be improved. However, the sensor 20 and the connection part 41 may be formed separately. In the case of this configuration, the sensor 20 may be configured of, for example, a rigid board or a rigid flexible board.

FIG. 6A is a plan view showing an example of a configuration of the sensor 20. The sensor 20 has a plurality of sensing parts SE, and these plurality of sensing parts SE are disposed in a row at equal intervals in the longitudinal direction of the sensor 20. However, the intervals of the sensing parts SE are not limited to equal intervals and the parts may be disposed at unequal intervals in accordance with desired characteristics. Each sensing part SE is provided at a position corresponding to the button BT and detects pressing of the button BT.

FIG. 6B is a cross-sectional view showing an example of the configuration of the sensor 20. The sensor 20 includes a support base material 21, an elastic layer (a first elastic layer) 22 provided on the support base material 21, and a sensor body 20A which is provided on the elastic layer 22 and includes a plurality of electrostatic capacitive sensing parts SE. The support base material 21 and the elastic layer 22 are bonded by a bonding layer 22A such that areas corresponding to the sensing parts SE become non-bonded areas AR. Specifically, the non-bonded areas AR are provided at a position overlapping the sensing part SE in a thickness direction of the sensor 20. Further, the elastic layer 22 and the sensor body 20A are also bonded by a bonding layer 22B. Examples of shapes of the non-bonded areas AR include a circular shape, an elliptical shape, a polygonal shape such as a rectangular shape, an indefinite shape, and the like, and the shape is not particularly limited to these shapes.

The sensor body 20A includes a REF layer (a first REF layer) 23 provided on the elastic layer 22, a second REF layer (a second REF layer) 24 provided apart from the REF layer 23, a sensor electrode layer 25 which is provided between the REF layer 23 and the REF layer 24 and includes a plurality of sensing parts SE, a support layer 26 provided between the REF layer 23 and the sensor electrode layer 25, and a support layer 27 provided between the REF layer 24 and the sensor electrode layer 25.

(Ref Layer)

The REF layers 23 and 24 are so-called ground electrodes and have a ground potential. The REF layers 23 and 24 are, for example, flexible metal layers. The metal layers contain, for example, at least one metal selected from the group consisting of aluminum, titanium, zinc, nickel, magnesium, copper and iron. The metal layers may contain an alloy containing at least one of the above metals. Specific examples of the alloy include stainless steel (stainless used steel: SUS), aluminum alloys, magnesium alloys, titanium alloys and the like.

In order to increase an amount of the REF layer 23 pushed up into a space 26B when the button BT is pressed, a thickness of the REF layer 23 is preferably thin. Specifically, the thickness of the REF layer 23 is preferably 100 μm or less, more preferably 65 μm or less, and even more preferably 30 μm or less. Also, details of the mechanism by which the REF layer 23 is pushed up into the space 26B will be described later.

(Support Layer)

The support layer 26 supports the sensor electrode layer 25 on the REF layer 23 and separates the REF layer 23 from the sensor electrode layer 25. The support layer 26 has spaces (first spaces) 26B between the REF layer 23 and the sensing parts SE.

More specifically, the support layer 26 includes a plurality of supports 26A. The plurality of supports 26A are disposed in a row to be separated at predetermined intervals in the longitudinal direction of the sensor 20, and the spaces 26B are provided between the supports 26A adjacent to each other. The sensing parts SE are provided on the spaces 26B. The supports 26A are made of, for example, an adhesive or a double-sided adhesive tape. For the adhesive, for example, an ultraviolet curable resin, a thermosetting resin or the like can be used. The supports 26A may be elastically deformed by a pressure applied when the first surface S1 of the sensor 20 is pressed.

The support layer 27 supports the REF layer 24 on the sensor electrode layer 25 and separates the sensor electrode layer 25 from the REF layer 24. The support layer 27 has spaces (second spaces) 27B between the REF layer 24 and the sensing parts SE.

More specifically, the support layer 27 includes a plurality of supports 27A. The plurality of supports 27A are disposed in a row to be separated at predetermined intervals in the longitudinal direction of the sensor 20, and spaces 27B are provided between the supports 27A adjacent to each other. The spaces 27B are provided on the sensing parts SE. As a material of the supports 27A, the same material as the supports 26A can be exemplified. The supports 27A may be elastically deformed by the pressure applied when the first surface S1 of the sensor 20 is pressed.

(Sensor Electrode Layer)

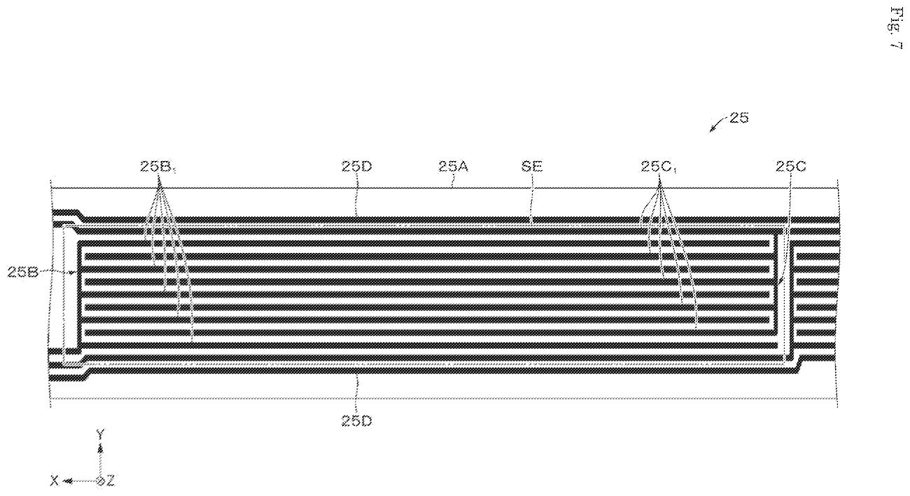

FIG. 7 shows an example of a configuration of the sensor electrode layer 25. The sensor electrode layer 25 includes a base material 25A, and a pulse electrode (a first electrode) 25B and a sense electrode (a second electrode) 25C which are provided on one principal surface of the base material 25A, and these pulse electrode 25B and sense electrode 25C constitute the sensing part SE. In addition, the sensor electrode layer 25 includes a linear ground electrode 25D which is provided on one principal surface of the base material 25A to surround a periphery of the sensing part SE. Further, the sensor electrode layer 25 may be provided with an insulating layer (not shown) such as a coverlay film, which covers the pulse electrode 25B, the sense electrode 25C, and the ground electrode 25D, on one principal surface of the sensor electrode layer 25.

The base material 25A is a flexible film containing a polymer resin. The polymer resin includes, for example, at least one selected from the group consisting of polyethylene terephthalate (PET), polyethylene naphthalate (PEN), polycarbonate (PC), an acrylic resin (PMMA), polyimide (PI), triacetyl cellulose (TAC), polyester, polyamide (PA), aramid, polyethylene (PE), polyacrylate, polyether sulfone, polysulfone, polypropylene (PP), diacetyl cellulose, polyvinyl chloride, an epoxy resin, a urea resin, a urethane resin, a melamine resin, a cyclic olefin polymer (COP) and a norbornene-based thermoplastic resin.

The pulse electrode 25B and the sense electrode 25C have comb-tooth shapes and are disposed to mesh their comb-tooth parts with each other. Specifically, the pulse electrode 25B includes a plurality of linear sub-electrodes 25B₁. The sense electrode 25C includes a plurality of linear sub-electrodes 25C₁. The plurality of sub-electrodes 25B₁ and 25C₁ extend in the X axis direction and are alternately provided to be separated at predetermined intervals in the Y axis direction. The sub-electrodes 25B₁ and 25C₁ adjacent to each other are configured such that they can form a capacitive coupling.

The sub-electrodes 25B₁ and 25C₁ adjacent to each other can operate as two mutual capacitive electrodes and can also operate as one self-capacitive electrode. Further, they can also be used as a capacitor for resonance of an LC resonance circuit along with the sensing by utilizing an electrostatic capacitance due to the coupling between the sub electrodes 25B₁ and 25C₁ adjacent to each other.

In the mutual capacitive method, an IC 12A detects an approach of the REF layers 23 and 24 to the sensing part SE on the basis of a change in electrostatic capacitance (specifically, a change in electrostatic capacitance between the pulse electrode 25B and the sense electrode 25C) of the sensing part SE. Further, in the IC 12A, the approach of the REF layers 23 and 24 to the sensing part SE is detected as a decrease in electrostatic capacitance between the pulse electrode 25B and the sense electrode 25C.

(Support Base Material)

The support base material 21 is for supporting the elastic layer 22 on a second surface S2 side of the sensor 20 so that the sensor 20 can be easily accommodated in the groove part 14. The support base material 21 has a flat plate shape. The support base material 21 contains a polymer resin or a metal. The support base material 21 may be a laminate of a polymer resin layer and a metal layer. As the polymer resin, the same material as the base material 25A can be exemplified. As the metal, the same materials as those of the REF layers 23 and 24 can be exemplified.

(Elastic Layer)

The elastic layer 22 is configured to be elastically deformable by pressing the first surface S1 of the sensor 20. Further, the elastic layer 22 is configured such that the REF layer 23 can be pushed up into the space 26B by pressing the first surface S1 of the sensor 20.

The elastic layer 22 contains, for example, a foamed resin, an elastomer or a gel. The foamed resin is a so-called sponge and is, for example, at least one of polyurethane foam, polyethylene foam, polyolefin foam, sponge rubber and the like. The elastomer is, for example, at least one of a silicone-based elastomer, an acrylic-based elastomer, a urethane-based elastomer, a styrene-based elastomer, and the like. Also, the elastic layer 22 may be provided on a base material (not shown). The gel is, for example, a silicone gel.

In a case in which the elastic layer 22 contains the foamed resin, the 25% compression load (25% Compression-Load-Deflection (CLD)) of the elastic layer 22 is preferably 0.1 MPa or more and 0.3 MPa or less, and more preferably 0.18 MPa or more and 0.25 MPa or less. Also, the above 25% compression load is a value measured in accordance with JIS K 6254.

In a case in which the elastic layer 22 contains the elastomer, a hardness of the elastic layer 22 is preferably A15 or more and A55 or less, and more preferably A20 or more and A35 or less in the durometer type A. Also, the above hardness is a value measured in accordance with JIS K 6253.

(Bonding Layer)

The bonding layers 22A and 22B contain an adhesive. The adhesive includes, for example, at least one selected from the group consisting of an acrylic adhesive, a silicone adhesive, and a urethane adhesive. Also, in the present disclosure, pressure sensitive adhesion is defined as a type of adhesion. According to this definition, a pressure sensitive adhesive is considered a type of adhesive.

(Board)

The board 12 is a main board of the electronic device 10 and includes a controller IC (hereinafter simply referred to as “IC”) 12A and a main central processing unit (CPU) (hereinafter simply referred to as “CPU”) 12B. The IC 12A is a control part that controls the sensor 20 and detects the pressure applied to the first surface S1 of the sensor 20. The CPU 12B is a control part that controls the entire electronic device 10. For example, the CPU 12B executes various processes on the basis of detection signals supplied from the IC 12A.

(Front Panel)

The front panel 13 includes a display apparatus 13A, and an electrostatic capacitive touch panel is provided on a surface of the display apparatus 13A. The display apparatus 13A displays a video (a screen) on the basis of video signals or the like supplied from the CPU 12B. Examples of the display apparatus 13A include a liquid crystal display, an electro luminescence (EL) display, and the like, but are not limited thereto.

[Detection Operation Performed when Button is Pressed]

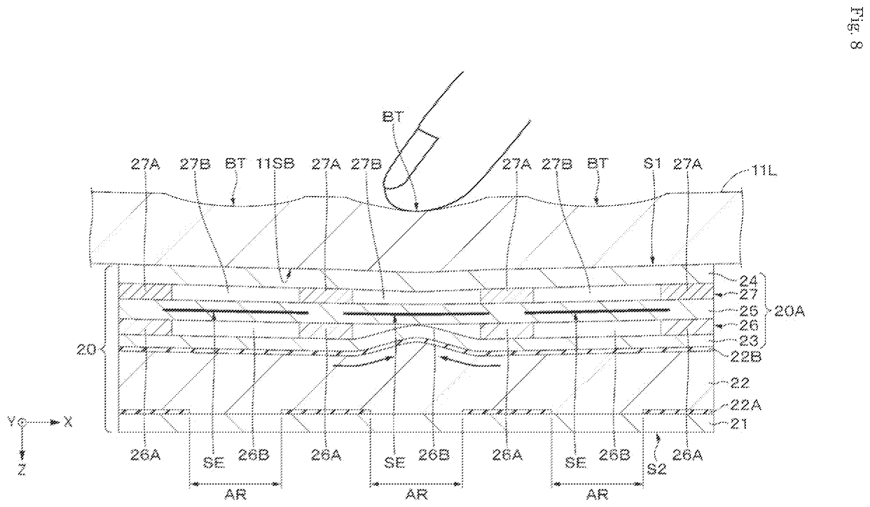

Hereinafter, an example of a detection operation performed when the button is pressed (when the surface of the housing is pressed) will be described with reference to FIG. 8.

When the button BT is pressed, the side wall part 11L bends toward the first surface S1 of the sensor 20, and the first surface S1 of the sensor 20 is pressed. Then, the REF layer 24 is pushed down into the space 27B due to the pressing on the first surface S1 and bends toward the sensing part SE. As a result, the REF layer 24 approaches the sensing part SE.

Further, due to broad deformation of the side wall part 11L resulting from the pressing on the button BT, the sensor body 20A bends toward the elastic layer 22 over a wide range, and the elastic layer 22 is crushed. The crushed elastic layer 22 performs a volume movement toward the space 26B as shown by arrows in FIG. 8, and as a result, the REF layer 23 is pushed up into the space 26B and bends toward the sensing part SE. As a result, the REF layer 23 approaches the sensing part SE. At this time, the REF layer 23 may come into contact with the sensor electrode layer 25, and the sensing part SE may be pushed up toward the REF layer 24. Since the non-bonded area AR1 is provided as described above, the volume movement of the elastic layer 22 described above can be increased. Therefore, the bending of the REF layer 23 toward the sensing part SE can be further increased.

As described above, when the REF layers 23 and 24 approach the sensing part SE, some lines of electric force between the pulse electrode 25B and the sense electrode 25C flow through the REF layers 23 and 24, and the electrostatic capacitance of the sensing part SE changes. The IC 12A detects the pressure applied to the first surface S1 of the sensor 20 on the basis of the change in the electrostatic capacitance and outputs the result to the CPU 12B. The CPU 12B executes various processes on the basis of the detection result supplied from the IC 12A.

In the case in which the REF layer 23 comes into contact with the sensor electrode layer 25 and the sensing part SE is pushed up toward the REF layer 24, the REF layer 24 and the sensing part SE can be brought closer by the pushing up. Therefore, the change in the electrostatic capacitance of the sensing part SE due to the pressing on the button BT can be further increased. Accordingly, detection sensitivity of the sensor 20 can be improved.

### Effects

The electronic device 10 according to the first embodiment includes the sensor 20 on the inner surface 11SB of the side wall part 11L, and the sensor 20 includes the sensor body 20A on the elastic layer 22. Thus, when the button BT is pressed, the side wall part 11L is deformed in a broad region, the elastic layer 22 is crushed, and the crushed elastic layer 22 performs a volume movement toward the space 26B. Then, this volume movement pushes up the REF layer 23 into the space 26B, and the REF layer 23 approaches the sensing part SE.

Further, the support base material 21 and the elastic layer 22 are bonded to each other by the bonding layer 22A such that the area corresponding to each of the sensing parts SE becomes the non-bonded area AR. Thus, since the volume movement of the elastic layer 22 described above can be increased, and the amount of pushing up the REF layer 23 toward the space 26B can be increased, the REF layer 23 can be brought closer to the sensing part SE.

Therefore, even if the displacement amount of the side wall part 11L at the time of pressing the button BT is very small and the deformation of the side wall part 11L occurs as a broad form, the pressing on the button BT (that is, the pressing on the side wall part 11L) can be detected by the IC 12A.

Further, since the sensor 20 includes the elastic layer 22, the sensor 20 can be accommodated in the groove part 14 by compressing the elastic layer 22. Therefore, it is possible to inhibit generation of a gap between the first surface S1 or the second surface S2 of the sensor 20 and a wall surface of the groove part 14. That is, a dimensional tolerance of the groove part 14 can be absorbed.

### MODIFIED EXAMPLES

### Modified Example 1

The REF layers 23 and 24 may be provided on base materials. However, in order to increase the displacement amount (deflection amount) of the REF layers 23 and 24 when the button BT is pressed, the REF layers 23 and 24 are preferably used alone.

### Modified Example 2

A thickness of a part of the REF layer 23 corresponding to the sensing part SE may be thinner than the other parts. Specifically, a thickness of a part of the REF layer 23 overlapping the sensing part SE in the thickness direction of the sensor 20 may be thinner than those of the other parts. In this case, since the amount of pushing up the REF layer 23 toward the space 26B can be further increased at the time of pressing the button BT, the REF layer 23 can be brought closer to the sensing part SE. Therefore, the detection sensitivity of the sensor 20 can be further improved.

### Modified Example 3

Although the case in which the REF layer 24 has flexibility and the REF layer 24 bends when the button BT is pressed has been described in the first embodiment, the REF layer 24 may have almost no flexibility and may hardly bend at the time of pressing the button BT. In this case, the support layer 27 may not have the space 27B. In the above configuration, the IC 12A detects the pressing on the button BT on the basis of the change in electrostatic capacitance due to the change in distance between the REF layer 23 and the sensing part SE.

### Modified Example 4

In the first embodiment described above, the case in which the support layer 26 has the space 26B has been described, but the support layer 26 may not have the space 26B. In this case, the support layer 26 is configured of an elastic layer. As a material of the elastic layer, the same material as that of the elastic layer 22 can be exemplified. Further, the elastic layer 22 is configured such that the REF layer 23 is pushed up toward the sensing part SE by pressing the first surface S1 of the sensor 20 and the support layer 26 is crushed so that the REF layer 23 and the sensing part SE can be brought close to each other.

Similarly, the support layer 27 may not have the space 27B. In this case, the support layer 27 is configured of an elastic layer. As a material of the elastic layer, the same material as that of the elastic layer 22 can be exemplified.

### Modified Example 5

In the first embodiment described above, an example in which a plurality of sensing parts SE are disposed in a row in the longitudinal direction of the sensor 20 has been described, but a plurality of sensing parts SE may be disposed two-dimensionally in a matrix shape or the like.

### Modified Example 6

In the first embodiment described above, the case in which the sensor 20 has a plurality of sensing parts SE has been described, but the sensor 20 may have one sensing part SE.

### Modified Example 7

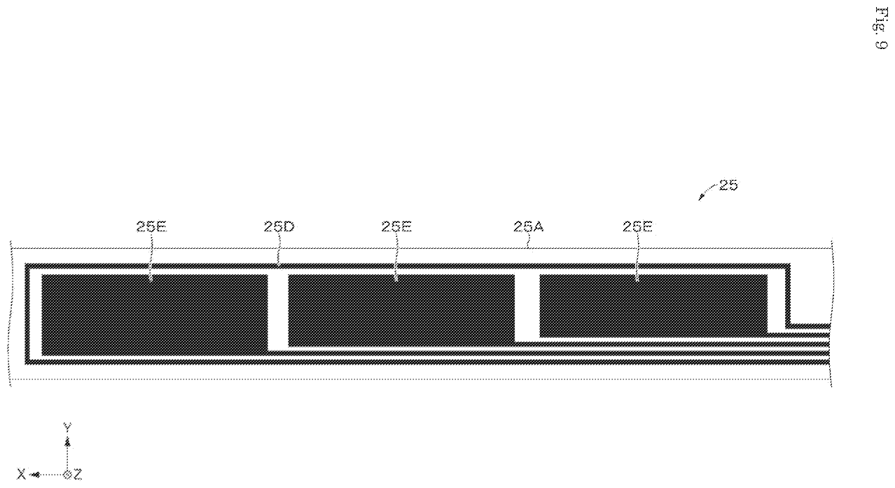

In the first embodiment described above, the case in which the sensor 20 is a mutual capacitive pressure sensor has been described, but it may be a self-capacitive pressure sensor. In this case, as shown in FIG. 9, rectangular electrodes may constitute the sense electrodes 25E. In addition, the linear ground electrode 25D may surround the plurality of sense electrodes 25E. Further, the sensing part SE may include a plurality of sense electrodes 25E, or the sensing part SE may include one sense electrode 25E.

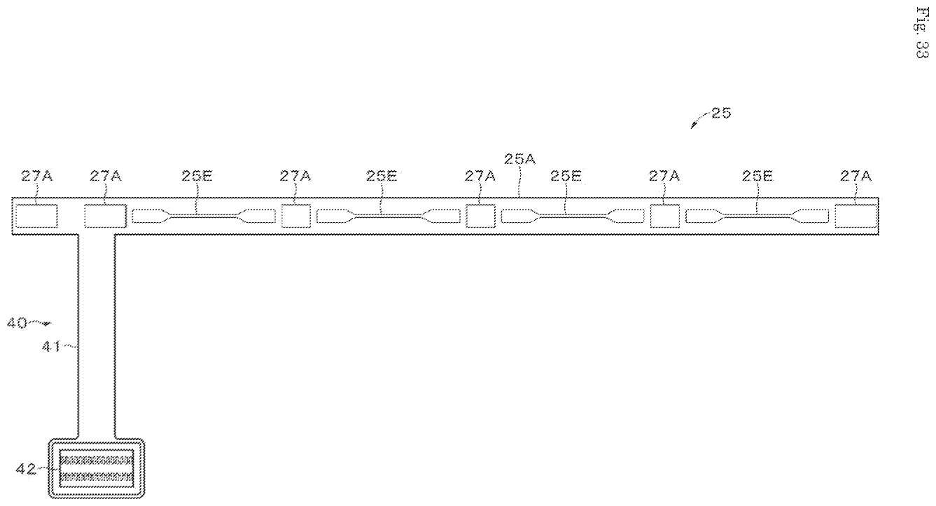

The shape of the sensor electrode 25E is not limited to a rectangular shape, and as shown in FIG. 33, a width of a central part thereof may be narrower than widths of both ends located on the support 27A sides. In this case, it is possible to inhibit a difference in load sensitivity between the case of pressing a vicinity of the support 27A and the case of pressing a vicinity of an intermediary position between the supports 27A adjacent to each other.

### Modified Example 8

The sensor 20 may not include the support base material 21, and a part of the housing 11 provided with the sensor 20 may be used as the base material.

### Modified Example 9

Although the configuration in which the sensor 20 includes the sensor body 20A and the elastic layer 22 between the side wall part 11L and the support base material 21, the sensor body 20A is provided on the side wall part 11L side, and the elastic layer 22 is provided on the support base material 21 side has been described in the first embodiment, the configuration of the sensor 20 is not limited thereto.

For example, an order in which constituent members of the sensor 20 are disposed in a direction from the side wall part 11L toward the support base material 21 may be reversed. That is, the elastic layer 22 may be disposed on the side wall part 11L side, the sensor body 20A may be provided on the support base material 21 side, and the non-bonded area AR may be provided between the side wall part 11L and the elastic layer 22. Even when such a configuration is adopted, the same effects as those of the first embodiment can be obtained.

Further, the elastic layer 22 and the non-bonded area AR may be provided on one surface side of the sensor body 20A, and an elastic layer 121 having an elastic modulus lower than that of the elastic layer 22 may be provided on the other surface side. Also, the elastic layer 121 may not be provided with the non-bonded area AR.

Further, the elastic layers 22 and the non-bonded areas AR may be provided on both sides of the sensor body 20A. In this case, one non-bonded area AR is provided between the side wall part 11L and the elastic layer 22, and the other non-bonded area AR is provided between the elastic layer 22 and the support base material 21. When such a configuration is adopted, volume movement effects due to both elastic layers 22 and the non-bonded areas AR can be obtained.

### Modified Example 10

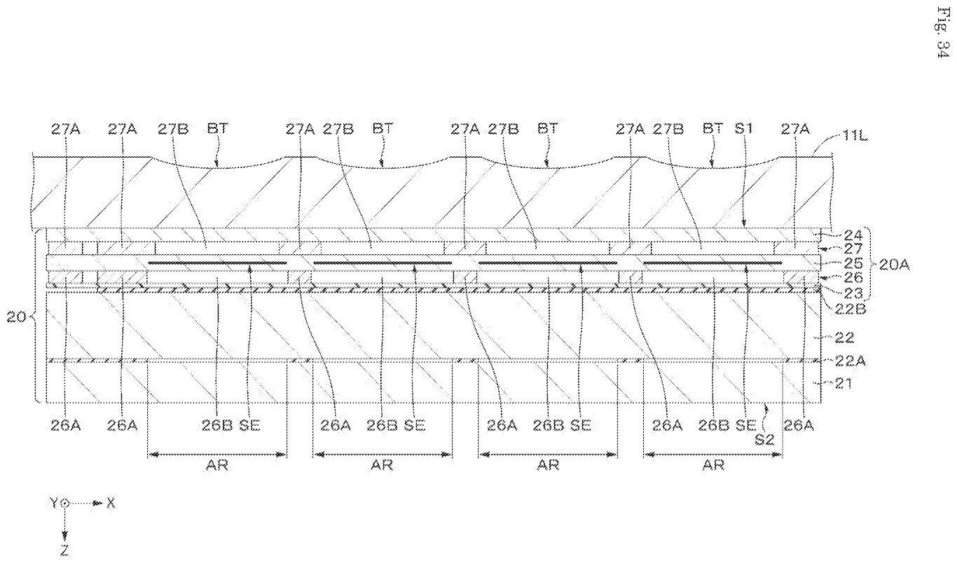

As shown in FIG. 34, the support 26A may be thinner than the support 27A. In this case, variation in a bending direction of the sensor electrode layer 25 can be inhibited. Center lines of the support 26A and the support 27A preferably coincide with each other, but the center lines of the support 26A and the support 27A may deviate from each other.

### Modified Example 11

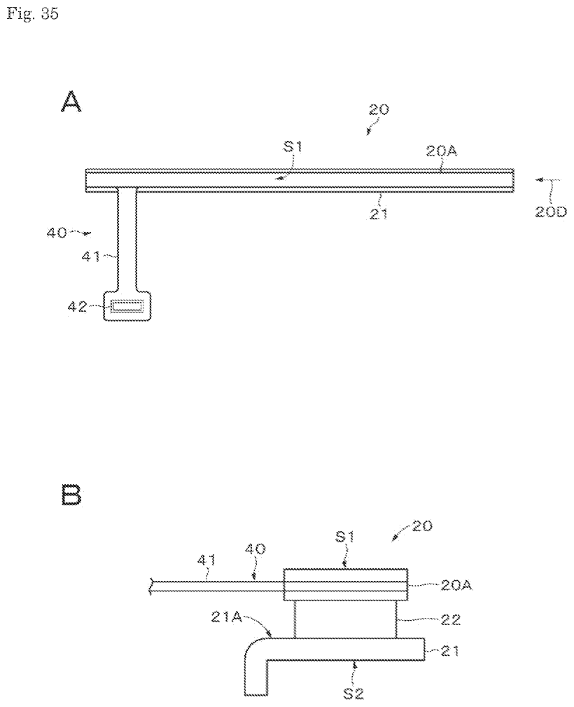

In the first embodiment, the case in which the support base material 21 has a flat plate shape has been described, but the shape of the support base material 21 is not limited thereto, and as shown in FIGS. 35A and 35B, the support base material 21 may have an L shape. In this case, the elastic layer 22 is bonded to one flat plate part 21A of the support substrate 21.

Further, in the first embodiment, the case in which the connection part 41 extends from the center of one long side of the sensor 20 has been described, but as shown in FIG. 35A, the connection part 41 may extend from the vicinity of an end of one long side of the sensor 20. Also, although FIGS. 35A and 35B show an example in which the connection part 41 extends parallel to the first surface S1 of the sensor 20, the connection part 41 may be bent.

(Examples of Electronic Device Other than Smartphone)

Although the case in which the electronic device is a smartphone has been described as an example in the first embodiment described above, the present disclosure is not limited thereto and is applicable to various electronic devices having an exterior body such as a housing. For example, the present disclosure is applicable to personal computers, mobile phones other than smartphones, TVs, remote controllers, cameras, game devices, navigation systems, e-books, electronic dictionaries, portable music players, keyboards, wearable terminals such as smart watches and head mounted displays, radios, stereos, medical devices, robots, and the like. Further, the present disclosure is also applicable to input apparatuses of these electronic devices. Also, the input apparatus includes, for example, an exterior body such as the housing and the sensor 20 provided on an inner surface of the exterior body. If necessary, the input apparatus may further include the IC 12A for detecting the pressing on the first surface S1 of the sensor 20.

(Examples Other than Electronic Devices)

The present disclosure is not limited to electronic devices and is applicable to various devices other than electronic devices. For example, the present disclosure is applicable to electric devices such as electric tools, refrigerators, air conditioners, water heaters, microwave ovens, dishwashers, washing machines, dryers, lighting devices, toys, and the like. Further, the present disclosure is also applicable to buildings such as houses, building members, vehicles, furniture such as tables and desks, manufacturing equipment, analytical instruments, and the like. Examples of the building members include paving stones, wall materials, floor tiles, floor boards, and the like. Examples of the vehicles include cars (for example, automobiles, motorcycles, etc.), ships, submarines, railroad cars, aircraft, spacecraft, elevators, play equipment, and the like. Further, the present disclosure is also applicable to an input apparatus included in something other than these electronic devices. Also, the input apparatus includes, for example, an exterior body such as the housing or an architectural element, and the sensor 20 provided on an inner surface of the exterior body. If necessary, the input apparatus may further include the IC 12A for detecting the pressing on the first surface S1 of the sensor 20.

### 2 Second Embodiment

### Overview

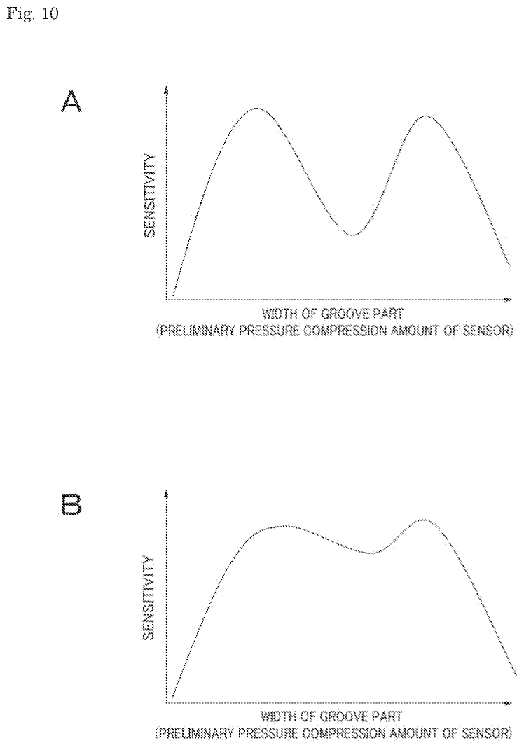

It is thought that a width W of the groove part 14 accommodating the sensor 20 (see FIG. 4) may have a dimensional tolerance. As described in the first embodiment, the sensor 20 includes the elastic layer 22 and the elastic layer 22 is compressed to accommodate the sensor 20 in the groove part 14, so that the dimensional tolerance can be absorbed. However, when the elastic layer 22 is compressed, as shown in FIG. 10A, sensitivity of the sensor 20 may change significantly due to variation in the width W of the groove part 14, that is, variation in a compression amount of the sensor 20 (elastic layer 22). This is due to the following reasons. That is, depending on the compression amount of the elastic layer 22, the REF layer 23 and the sensing part SE are in a very close state in advance. When the REF layer 23 and the sensing part SE are in such a very close state, the sensor 20 tends to have a large change in electrostatic capacitance in accordance with the pressing on the first surface S1.

As described above, when the sensitivity of the sensor 20 changes significantly due to the variation in the width W of the groove part 14, there is a risk that the sensitivity may vary greatly for each electronic device, and operability may differ for each electronic device. In addition, there is a risk that the operability of the electronic device may be uncomfortable. Therefore, as shown in FIG. 10B, it is desired to inhibit a change in sensitivity within the dimensional tolerance of the width W of the groove part 14. In a second embodiment, a sensor which can inhibit such a change in sensitivity will be described.

[Configuration of Sensor]

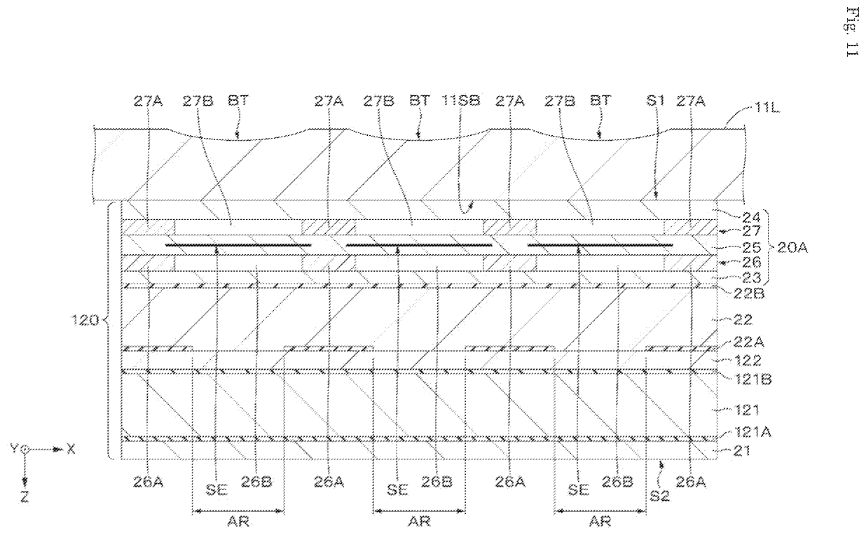

FIG. 11 shows an example of a configuration of a sensor 120 according to the second embodiment. The sensor 120 is different from the sensor 20 in that an elastic layer (a second elastic layer) 121 and a base material 122 are further provided between the support base material 21 and the elastic layer 22. Also, in the second embodiment, the same parts as those in the first embodiment are denoted by the same reference numerals, and descriptions thereof will be omitted.

The elastic layer 121 is provided on the support base material 21, the base material 122 is provided on the elastic layer 121, and the elastic layer 22 is provided on the base material 122. The base material 122 and the elastic layer 22 are bonded to each other by the bonding layer 22A such that the areas corresponding to the sensing parts SE become the non-bonded areas AR. The support base material 21 and the elastic layer 121 are bonded to each other by a bonding layer 121A. The elastic layer 121 and the base material 122 are bonded to each other by a bonding layer 121B.

The elastic layer 121 is configured to be elastically deformable by pressing the first surface S1 of the sensor 20. Further, the elastic layer 121 has a lower elastic modulus than the elastic layer 22, and is configured to be preferentially crushed with respect to the elastic layer 22 by pressing the first surface S1 of the sensor 120. As a material of the elastic layer 28, the same type as the elastic layer 22 can be exemplified. However, even if materials of the elastic layers 22 and 121 are the same type, elastic moduli of the elastic layers 22 and 121 are made to be different from each other by adjusting porosities, adjusting molecular weights, adding additives, etc.

The base material 122 has a function as a separating layer that separates deformations of the elastic layer 22 and the elastic layer 121 from each other. The base material 122 preferably has a higher elastic modulus than the elastic layers 22 and 121 in order to separate the deformations of the elastic layer 22 and the elastic layer 121 from each other. As a material of the base material 122, the same material as that of the support base material 21 can be exemplified.

### Effects

The sensor 120 according to the second embodiment includes the elastic layer 22 on the elastic layer 121 via the base material 122, and the elastic layer 121 has a lower elastic modulus than the elastic layer 22. Thus, since the elastic layer 121 is crushed preferentially over the elastic layer 22 when the sensor 20 is compressed and accommodated in the groove part 14, the overall sensitivity can be reduced as compared with the sensor 20. Therefore, it is possible to inhibit the change in sensitivity within the dimensional tolerance of the width W of the groove part 14.

### 3 Third Embodiment

In a third embodiment, a sensor which can inhibit the change in sensitivity within the dimensional tolerance of the width W of the groove part 14 using a configuration different from that of the second embodiment will be described.

[Configuration of Sensor]

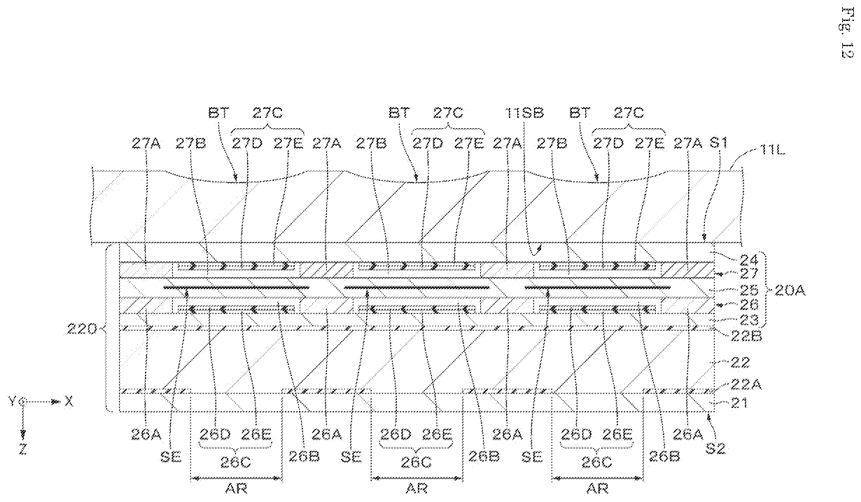

FIG. 12 shows an example of the configuration of the sensor 220 according to the third embodiment. The sensor 220 is different from the first embodiment in that a plurality of structures (first structures) 26C which are provided respectively in the spaces 26B and are lower than a thickness of the support layer 26 (that is, the height of the support 26A) and a plurality of structures (second structures) 27C which are provided respectively in the spaces 27B and are lower than a thickness of the support layer 27 (that is, the height of the support 27A) are further provided. Also, in the third embodiment, the same parts as those in the first embodiment are denoted by the same reference numerals, and descriptions thereof will be omitted.

The structures 26C are provided on parts of a first surface of the REF layer 23 that face the sensing parts SE. The structures 26C are for inhibiting the REF layer 23 and the sensor electrode layer 25 from being too close to each other when the first surface S1 of the sensor 220 is pressed.

The structures 27C are provided on parts of a first surface of the REF layer 24 that face the sensing parts SE. The structures 27C are for inhibiting the REF layer 24 and the sensor electrode layer 25 from being too close to each other when the first surface S1 of the sensor 20 is pressed.

A ratio R1(=(h2/h1)×100)% of a height h2 of the structure 26C to a height h1 of the support 26A is preferably 10% or more and 40% or less, and more preferably 20% or more and 30% or less. When the ratio R1 is 10% or more, it is possible to particularly inhibit the change in sensitivity within the dimensional tolerance of the width W of the groove part 14. On the other hand, when the ratio R1 is 40% or less, it is possible to particularly inhibit a decrease in the detection sensitivity of the sensor 220 even if the structure 26C is provided.

A ratio R2(=(h4/h3)×100)% of a height h4 of the structure 27C to a height h3 of the support 27A is preferably 10% or more and 40% or less, and more preferably 20% or more and 30% or less. When the ratio R2 is 10% or more, it is possible to particularly inhibit the change in sensitivity within the dimensional tolerance of the width W of the groove part 14. On the other hand, when the ratio R2 is 40% or less, it is possible to particularly inhibit a decrease in the detection sensitivity of the sensor 220 even if the structure 27C is provided.

The structure 26C is made of a so-called single-sided adhesive tape and specifically includes a polymer film 26D and an adhesive layer 26E for bonding the polymer film 26D to the REF layer 23. The structure 27C is also made of a so-called single-sided adhesive tape and specifically includes a polymer film 27D and an adhesive layer 27E for bonding the polymer film 27D to the REF layer 24. Further, the structures 26C and 27C may be made of an ultraviolet curable resin, a thermosetting resin, or the like.

### Effects

The sensor 220 according to the third embodiment further includes the structure 26C in the space 26B, and further includes the structure 27C in the space 27B. Thus, when the button BT (that is, the first surface S1 of the sensor 20) is pressed while the elastic layer 22 is compressed and the sensor 20 is accommodated in the groove part 14, it is possible to prevent the REF layers 23 and 24 and the sensing parts SE from being too close to each other. Therefore, it is possible to inhibit the change in sensitivity within the dimensional tolerance of the width W of the groove part 14.

### MODIFIED EXAMPLES

### Modified Example 1

In the third embodiment, the configuration in which the sensor 220 includes both the structure 26C and the structure 27C has been described, but one of the structure 26C and the structure 27C may be provided.

### Modified Example 2

The structure 26C may be provided at the position corresponding to the sensing part SE on a first surface of the sensor electrode layer 25, and the structure 27C may be provided at the position corresponding to the sensing part SE on a second surface of the sensor electrode layer 25. Here, the first surface of the sensor electrode layer 25 is a surface of both surfaces of the sensor electrode layer 25 that faces the REF layer 23, and the second surface of the sensor electrode layer 25 is a surface of both surfaces of the sensor electrode layer 25 that faces the REF layer 24.

Further, the structures 26C may be provided on both the first surface of the REF layer 23 and the first surface of the sensor electrode layer 25, and the structures 27C may be provided on both the first surface of the REF layer 24 and the second surface of the sensor electrode layer 25.

### Modified Example 3

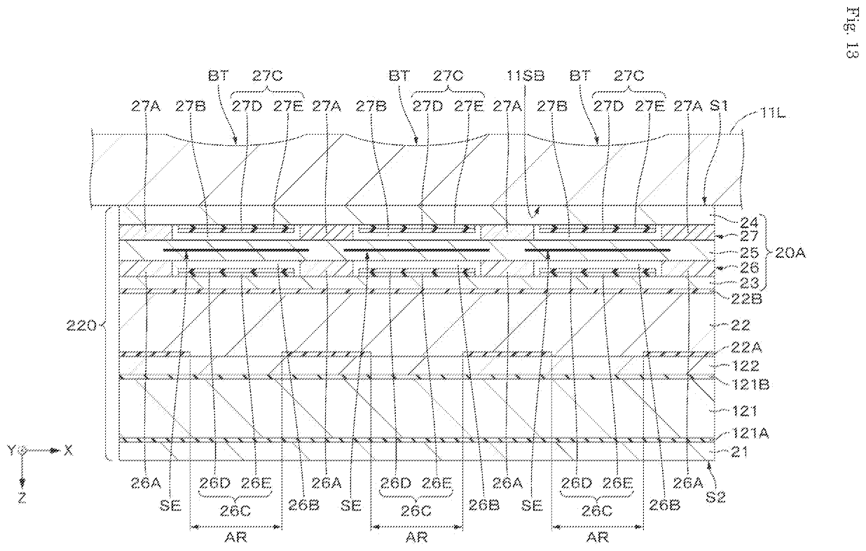

As shown in FIG. 13, the sensor 220 may further include the elastic layer 121 and the base material 122 between the support base material 21 and the elastic layer 22 as in the second embodiment. In this case, the change in sensitivity within the dimensional tolerance of the width W of the groove part 14 can be further inhibited.

### 4 Fourth Embodiment

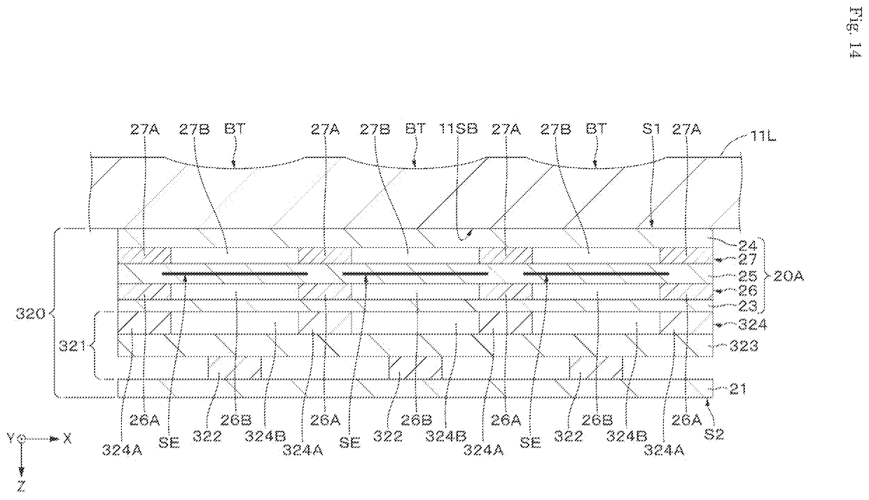

FIG. 14 shows an example of a configuration of a sensor 320 according to a fourth embodiment. The sensor 320 is different from the first embodiment in that a spring structure part 321 is provided between the support base material 21 and the REF layer 23 instead of the elastic layer 22. Also, in the fourth embodiment, the same parts as those in the first embodiment are denoted by the same reference numerals, and descriptions thereof will be omitted.

The spring structure part 321 includes a plurality of structures 322 provided on the support base material 21, a spring member 323 provided on the plurality of structures 322, and a support layer 324 provided on the spring member 323.

(Support Layer)

The support layer 324 supports the sensor body 20A on the spring member 323 and separates the spring member 323 from the REF layer 23. The support layer 324 has a space 324B at a position corresponding to each sensing part SE. That is, the support layer 324 has the space 324B at the position overlapping each sensing part SE in the thickness direction of the sensor 320.

More specifically, the support layer 324 includes a plurality of supports 324A. The plurality of supports 324A are disposed in a row to be separated at predetermined intervals in the longitudinal direction of the sensor 320, and the sensing parts SE are positioned between the supports 324A adjacent to each other in the longitudinal direction of the sensor 320. The spaces 324B are provided between the supports 324A adjacent to each other, respectively.

As a material of the support 324A, the same material as the support 26A in the first embodiment can be exemplified. Also, the support 324A may be a convex part integrally formed on a surface of the spring member 323, or may be a convex part integrally formed on a surface of the REF layer 23.

(Structures)

The structures 322 are for pushing up the spring member 323 toward the REF layer 23 when the button BT (first surface S1 of the sensor 320) is pressed. The structures 322 have columnar shapes. Each of the plurality of structures 322 is provided on the support base material 21 at the parts corresponding to the sensing parts SE. Specifically, each of the plurality of structures 322 is provided at the positions overlapping the sensing parts SE in the thickness direction of the sensor 320.

As a material of the structure 322, the same material as the support 26A in the first embodiment can be exemplified. Also, the structure 322 may be a convex part integrally formed on a surface of the support base material 21.

(Spring Member)

The spring member 323 has a film shape and functions as a so-called leaf spring. Specifically, when the button BT is pressed, the spring member 323 is pushed up and bent by the structure 322, and when the pressure is released, the spring member 323 returns to the original flat state threreof.

The spring member 323 contains a polymer resin or a metal. The spring member 323 may be a laminate of a polymer resin layer and a metal layer. As the polymer resin, the same material as the base material 25A can be exemplified. As the metal, the same materials as those of the REF layers 23 and 24 can be exemplified.

### Effects

The sensor 320 according to the fourth embodiment includes the spring structure part 321 between the support base material 21 and the REF layer 23, and the spring structure part 321 includes the plurality of structures 322, the spring member 323, and the support layer 324. Thus, when the button BT is pressed, the spring member 323 is pushed up and bent by the structure 322A and the bent part pushes up the REF layer 23 into the space 26B through the space 324B, so that the REF layer 23 and the sensing part SE approach each other. Therefore, similarly to the sensor 20 according to the first embodiment, even if the displacement amount of the side wall part 11L at the time of pressing the button BT is very small and the deformation of the side wall part 11L occurs in a broad region, the pressing on the button BT (that is, the pressing on the side wall part 11L) can be detected by the IC 12A.

Further, since the sensor 320 according to the fourth embodiment includes the spring structure part 321 instead of the elastic layer 22 in the first embodiment, the following advantages can be obtained.

(a) In the spring structure part 321, temperature dependence can be made smaller than the case of using the elastic layer 22.

(b) Since variations in thickness of the spring structure part 321 are usually smaller than variations in thickness of the elastic layer 22, the spring structure part 321 can inhibit the variations in thickness as compared with the elastic layer 22.

(c) The spring structure part 321 can inhibit plastic deformation (deformation that does not return from the pressed state) as compared with the elastic layer 22.

(d) The spring structure part 321 can inhibit variations in hardness as compared with the elastic layer 22.

(e) When a commercially available elastic layer (for example, a foamed resin layer) is used as the elastic layer 22, variations in the thickness thereof, material, and the like are limited, and thus it is not easy to adjust the elastic layer 22 to a desired hardness. On the other hand, in the spring structure part 321, the spring structure part 321 can be easily adjusted to a desired hardness in accordance with positions of the supports 324A, a thickness of the spring member 323, and the like. Therefore, the hardness of the spring structure part 321 can be easily adjusted as compared with the elastic layer 22.

Further, costs for the sensor 320 according to the fourth embodiment can be reduced as compared with the sensor 120 according to the second embodiment including the two elastic layers 22 and 121.

### MODIFIED EXAMPLES

Although the configuration in which the sensor 320 includes the sensor body 20A and the spring structure part 321 between the side wall part 11L and the support base material 21, the sensor body 20A is provided on the side wall part 11L side, and the spring structure part 321 is provided on the support base material 21 side has been described in the fourth embodiment, the configuration of the sensor 320 is not limited thereto.

For example, the order in which constituent members of the sensor 320 are disposed in the direction from the side wall part 11L toward the support base material 21 may be reversed. That is, the spring structure part 321 may be provided on the side wall part 11L side, and the sensor body 20A may be provided on the support base material 21 side. Even when such a configuration is adopted, the same effects as those of the fourth embodiment can also be obtained.

### 5 Fifth Embodiment

[Configuration of Sensor]

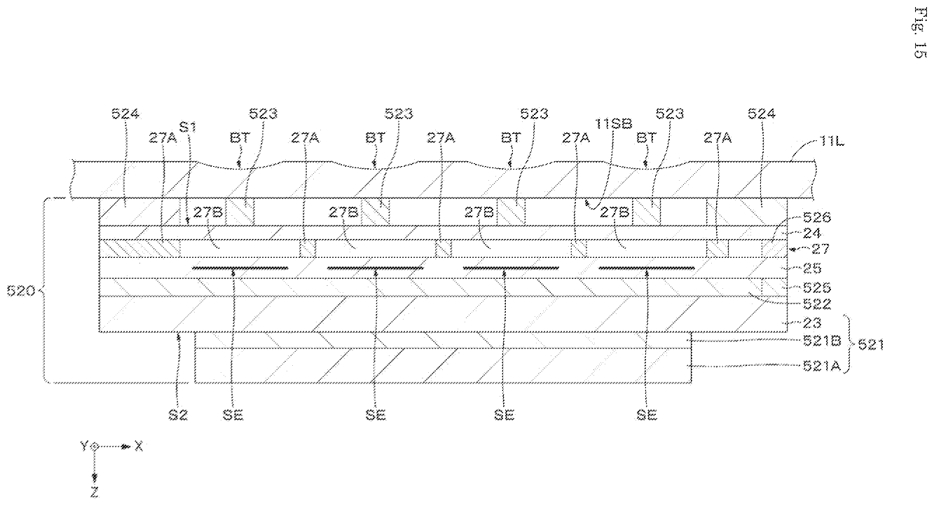

FIG. 15 shows an example of a configuration of a sensor 520 according to a fifth embodiment. The sensor 520 has an elongated film shape and includes an elongated reference electrode member (hereinafter referred to as a “REF member”) 521, an elongated REF layer (a second REF layer) 24 provided apart from the REF member 521, a sensor electrode layer 25 which is provided between the REF member 521 and the REF layer 24 and includes a plurality of sensing parts SE, a gap layer 522 provided between the REF member 521 and the sensor electrode layer 25, a support layer 27 provided between the REF layer 24 and the sensor electrode layer 25, and a plurality of pushers 523 and two supports 524 provided on the REF layer 24.

Further, the sensor 520 includes a connecting member 525 such as an anisotropic conductive film (ACF) that connects a first ground electrode (not shown) of the sensor electrode layer 25 with the REF member 521, and a connecting member 526 such as an ACF that connects a second ground electrode (not shown) of the sensor electrode layer 25 with the REF layer 24. The REF member 521 is grounded via the connecting member 525 and the first ground electrode to have a ground potential. Also, the REF layer 24 is grounded via the connecting member 526 and the second ground electrode to have a ground potential. Also, in the fifth embodiment, the same parts as those in the first embodiment are denoted by the same reference numerals, and descriptions thereof will be omitted.

As shown in FIG. 15, the sensor 520 is used while bonded to the inner surface 11SB of the side wall part 11L. For this reason, the pressing from the groove part 14 (see FIG. 4) and the second surface S2 in the first embodiment may not be necessary. Further, the sensor 520 may include a release film on the first surface S1 side in a state before being boned to the inner surface 11SB of the side wall part 11L.

(Ref Member)

The REF member 521 has a film shape, and thicknesses of both ends in a longitudinal direction thereof are made thinner. Specifically, the REF member 521 has a step on a surface opposite to a surface facing the sensor electrode layer 25 near both ends of the surface. Therefore, both ends of the REF member 521 have lower rigidity than the other parts. Here, the rigidity means rigidity of the sensor 520 in the thickness direction.

The REF member 521 includes a support base material 521A and a REF layer 23 provided on the support base material 521A. The support base material 521A and the REF layer 23 are bonded by a bonding layer 521B.

The support base material 521A is for supporting a part of the sensor 520 on the second surface S2 side excluding both ends in the longitudinal direction of the sensor 520A and has a flat thin plate shape or a film shape. Both the support base material 521A and the REF layer 23 have elongated shapes, and both ends of the support base material 521A in the longitudinal direction are positioned inside both ends of the REF layer 23 in the longitudinal direction. Therefore, as described above, both end parts of the REF member 521 in the longitudinal direction have lower rigidity than the other parts.

One end of the support base material 521A is preferably provided at a position inside the support 27A or the support 524 positioned at one end in the longitudinal direction and outside the sensing part SE that is positioned second in a direction from one end toward the other end in the longitudinal direction. Further, the other end of the support base material is preferably provided at a position inside the support 27A or the support 524 positioned at the other end in the longitudinal direction and outside the sensing part SE that is positioned second in a direction from the other end toward one end in the longitudinal direction.

One end of the support base material 521A may be provided at a position overlapping the sensing part SE positioned at one longitudinal end in the thickness direction of the sensor 520. The other end of the support base material 521A may be provided at a position overlapping the sensing part SE positioned at the other longitudinal end in the thickness direction of the sensor 520.

For a material of the support base material 521A, a lightweight and highly rigid material such as a metal, a polymer resin, ceramics or wood can be used. In addition, two or more kinds of these materials may be laminated and used. As the metal, the same materials as those of the REF layers 23 and 24 can be exemplified. However, a metal having low conductivity other than those exemplified as the materials of the REF layers 23 and 24 may be used. As the polymer resin, the same material as the base material 25A can be exemplified. For the ceramics, for example, porous alumina ceramics, zirconia and the like can be used.

(Gap Layer)

The gap layer 522 has insulating properties and is for separating the REF layer 23 and the sensor electrode layer 25, and initial electrostatic capacitance of the sensor 520 is adjusted in accordance with a thickness of the gap layer 522. The gap layer 522 may be configured to be elastically deformable due to the pressure applied to the first surface S1 of the sensor 520, or may not be configured to be elastically deformable.

The gap layer 522 also serves as a bonding layer for bonding the REF layer 23 to the sensor electrode layer 25. The gap layer 522 is configured of, for example, a single adhesive layer or a laminate (for example, a double-sided adhesive film) in which adhesive layers are provided on both sides of a base material.

In a case in which the gap layer 522 is configured to be elastically deformable, the gap layer 522 includes, for example, an elastic layer and adhesive layers on both sides of the elastic layer. As a material of the elastic layer, the same material as the elastic layer 22 in the first embodiment can be exemplified.

(Pushers)

The pushers 523 are for concentrating a pressing force on positions in the REF layer 24 corresponding to the sensing parts SE at the time of pressing the button BT (at the time of pressing the surface of the housing). The pushers 523 may also serve as bonding parts for bonding the REF layer 24 and the inner surface 11SB of the side wall part 11L. The pushers 523 are made of, for example, an adhesive or a double-sided adhesive tape. For the adhesive, for example, an ultraviolet curable resin or a thermosetting resin can be used.

(Supports)

The two supports 524 are provided at both ends of the REF layer 24 in the longitudinal direction. The supports 524 support the side wall part 11L on the REF layer 24 and separate the REF layer 24 from the inner surface 11SB of the side wall part 11L. The supports 524 also serve as bonding parts for bonding the REF layer 24 to the inner surface 11SB of the side wall part 11L. The supports 524 are made of, for example, an adhesive or a double-sided adhesive tape. For the adhesive, for example, an ultraviolet curable resin or a thermosetting resin can be used.

[State of Sensor when Button is Pressed]

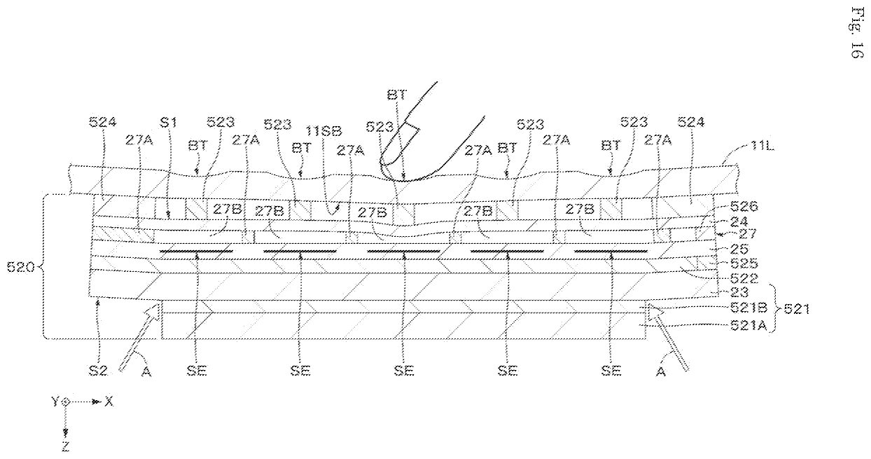

Hereinafter, an example of a detection operation at the time of pressing the button (at the time of pressing the surface of the housing) will be described with reference to FIG. 16.

For example, when the button BT corresponding to a center position of the sensor 520 is pressed, the side wall part 11L bends toward the first surface S1 of the sensor 20, and the pusher 523 is pressed. Then, the REF layer 24 is pushed down into the space 27B by the pressed pusher 523, and the REF layer 24 approaches the sensing part SE. Due to this approach, the electrostatic capacitance of the sensing part SE changes.

In the sensor 520 according to the first embodiment, the rigidity of both end parts of the sensor 520 in the longitudinal direction is made lower than that of the other parts, and thus when the button is pressed (when the sensor is pressed), both end parts of the sensor 520 in the longitudinal direction bend starting from stepped parts at which the thickness of the REF member 521 changes, which are indicated by arrows A in FIG. 16. Thus, the REF layer 24 can be brought closer to the sensing part SE as described above.

Further, in a case in which the REF member 521 does not include the support base material 521A and only includes the REF layer 23, the rigidity of both end parts of the sensor 520 in the longitudinal direction is not lower than the rigidity of the other parts, and thus the entire sensor 520 bends like a bow when the button BT is pressed. Therefore, it becomes difficult to bring the REF layer 24 closer to the sensing part SE as described above, and detection of the pressing on the button BT is difficult, or the detection sensitivity with respect to the pressing on the button BT is significantly reduced.

Also, similarly, in a case in which the support base material 521A and the REF layer 23 have the same size and both ends of the support base material 521A in the longitudinal direction are aligned with both ends of the REF layer 23 in the longitudinal direction, the entire sensor 520 bends like a bow when the button BT is pressed, and thus the same problem as above occurs.

### Effects

In the sensor 520 according to the fifth embodiment, thicknesses of both end parts of the REF member 521 in the longitudinal direction is thinned, and both end parts of the REF member 521 in the longitudinal direction have lower rigidity than the other parts. Thus, both end parts of the sensor 520 bend starting from the stepped parts at which the thickness of the REF member 521 changes, so that bending of the entire sensor 520 can be prevented. Therefore, the REF layer 24 can be brought close to the sensing part SE. Accordingly, the detection sensitivity of the sensor 520 can be improved.

### MODIFIED EXAMPLES

### Modified Example 1

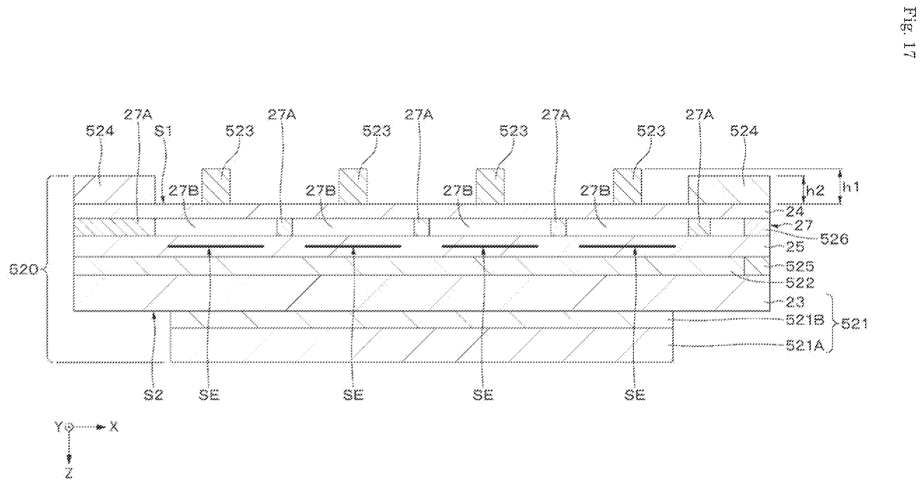

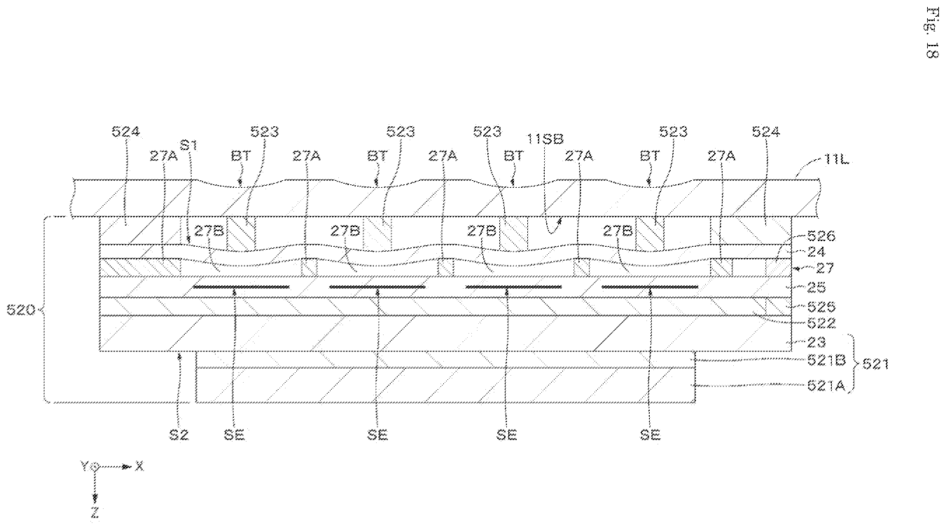

As shown in FIG. 17, a height h1 of the pusher 523 may be higher than a height h2 of the support 524. When the sensor 502 having such a configuration is attached to the inner surface 11SB of the side wall part 11L as shown in FIG. 18, the REF layer 24 is preliminarily pushed down into the spaces 27B by the pushers 523. Therefore, since the REF layer 422 and the sensing parts SE are in a state in which they have approached each other in advance, a change in electrostatic capacitance with respect to the pressing on the outer surface 11SA of the side wall part 11R becomes significant. Accordingly, the sensitivity of the sensor 520 can be improved.

### Modified Example 2

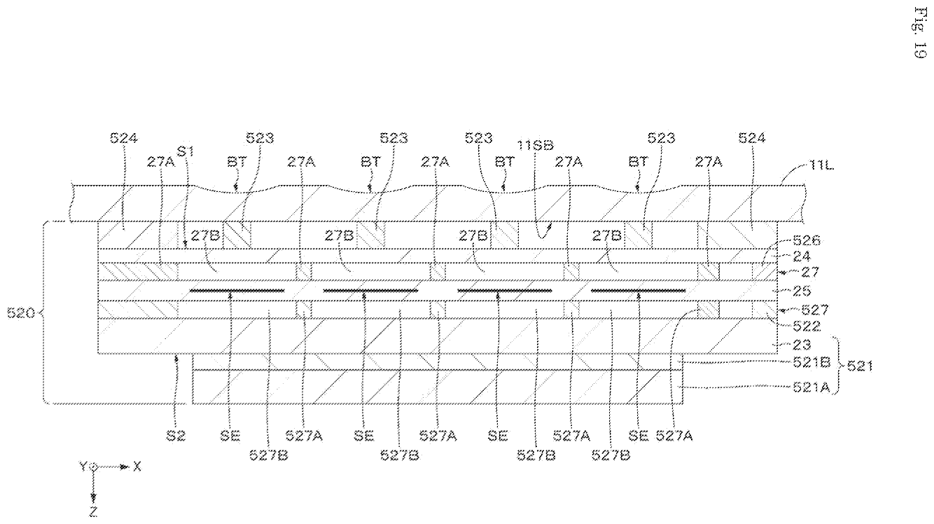

As shown in FIG. 19, the sensor 520 may include a gap layer 527 having a plurality of supports 527A. The plurality of supports 527A are disposed in a row to be separated at predetermined intervals in the longitudinal direction of the sensor 20, and spaces 527B are provided between the supports 527A adjacent to each other. The sensing parts SE are provided on the spaces 26B. As a material of the support 527A, the same material as the support 27A can be exemplified.

### Modified Example 3

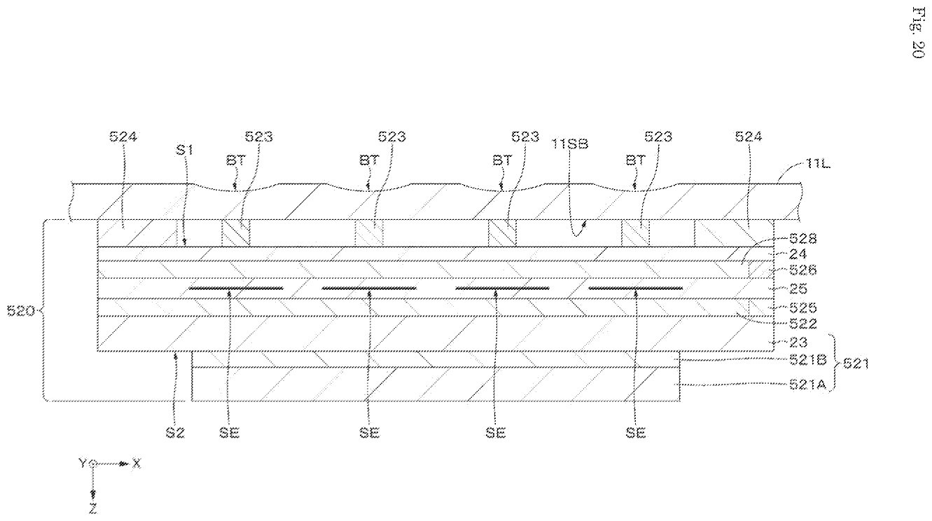

As shown in FIG. 20, the sensor 520 may include a film-shaped support layer 528 instead of the support layer 27 having the plurality of supports 27A. The support layer 528 is a so-called elastic layer and is configured to be elastically deformable when the first surface S1 of the sensor 520 is pressed. As a material of the support layer 528, the same material as the elastic layer 22 in the first embodiment can be exemplified. When the sensor 520 has the above configuration, it is preferable that one end of the support base material 521A in the longitudinal direction is provided at a position overlapping the sensing part SE positioned at one longitudinal end of the sensor electrode layer 25 in the thickness direction of the sensor 520, and the other end of the support base material 521A in the longitudinal direction is provided at a position overlapping the sensing part SE positioned at the other longitudinal end of the sensor electrode layer 25 in the thickness direction of the sensor 520.

### Modified Example 4

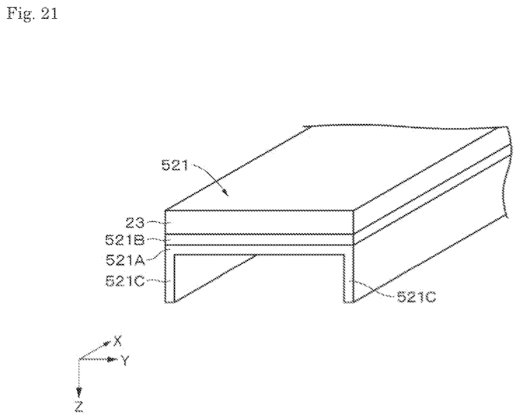

A shape of the support base material 521A is not particularly limited as long as both end parts of the REF member 521 in the longitudinal direction can have lower rigidity than the other parts. For example, as shown in FIG. 21, the support base material 521A may have wall parts 521C along both long sides thereof, and the support base material 521A may have a U-shape as a whole.

### Modified Example 5

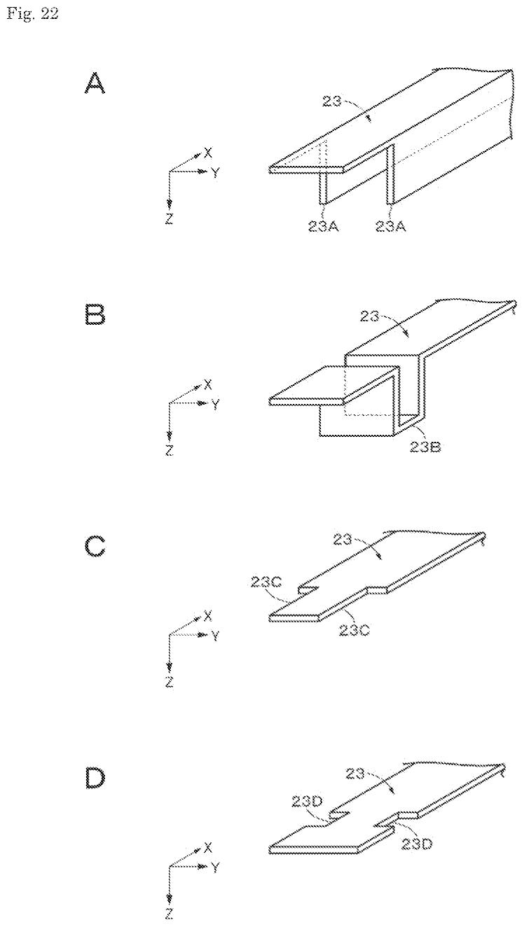

Instead of providing the support base material 521A, a shape of the REF layer 23 itself may be adjusted so that both end parts of the REF layer 23 in the longitudinal direction have lower rigidity than the other parts. For example, as shown in FIG. 22A, the REF layer 23 may have wall parts 23A at parts other than both end parts of both long sides thereof. Also, as shown in FIG. 22B, bent parts 23B may be provided at positions near both end parts of the REF layer 23 in the longitudinal direction to enhance spring properties of the REF layer 23. Further, as shown in FIG. 22C, notch parts 23C may be provided at both end parts of both long sides of the REF layer 23, and as shown in FIG. 22D, notch parts 23D may be provided in the vicinities of both end parts of both long sides of the REF layer 23. In addition, the REF layer 23 having the above-mentioned shape may be used in combination with the support base material 521A.

### Modified Example 6

The pushers 523 and the supports 524 can also be applied to the sensor 20 according to the first embodiment, the sensor 120 according to the second embodiment, the sensor 220 according to the third embodiment, and the sensor 320 according to the fourth embodiment. In this case, the pushers 523 and the supports 524 may not have a bonding function such as double-sided adhesiveness.

### Modified Example 7

The sensor 520 may not include the pushers 523 and the supports 524, and the first surface S1 of the sensor 520 may be bonded to the side wall part 11L without these members. In this case, in order to obtain the same effect of improving sensitivity as the pushers 523 shown in FIG. 17, a plurality of convex parts having a height corresponding to the difference between the height h1 and the height h2 may be provided at positions corresponding to the sensing parts SE on the inner surface 11SB of the side wall part 11L.

### Modified Example 8

The constituent members from the REF layer 23 to the REF layer 24 of the sensor 520 are replaceable with constituent members having the same functions in other embodiments. For example, the constituent members from the REF layer 23 to the REF layer 24 in the first embodiment (FIG. 6B) may be replaced with the constituent members from the REF layer 23 to the REF layer 24 in the fifth embodiment.

### 6 Sixth Embodiment

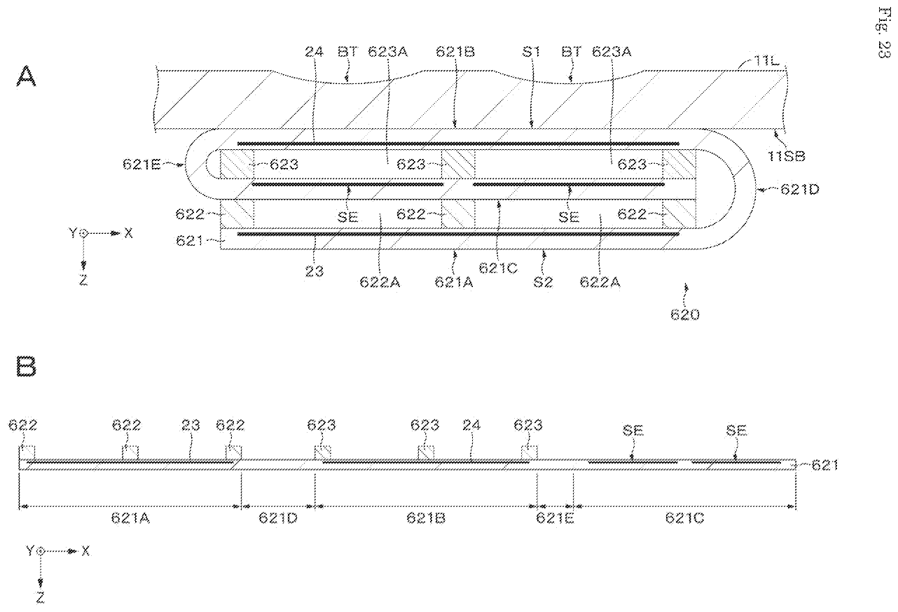

FIG. 23A is a cross-sectional view showing an example of a configuration of a sensor 620 according to a sixth embodiment. FIG. 23B is a development view showing the example of the configuration of the sensor 620 of the sixth embodiment. The sensor 620 generally has an elongated film shape and includes an elongated FPC 621, a plurality of supports 622, and a plurality of supports 623. The FPC 621 is provided with a reference electrode area (hereinafter referred to as a “REF area”) 621A, a folding area 621D, a REF area 621B, a folding area 621E, and a sensor electrode area 621C in order from one end to the other end in a longitudinal direction thereof. Also, in the fifth embodiment, the same parts as those in the first embodiment are denoted by the same reference numerals, and descriptions thereof will be omitted.

The FPC 621 is folded such that the REF area 621A and the sensor electrode area 621C face each other, and the REF area 621B and the sensor electrode area 621C face each other. The plurality of supports 622 are provided between the REF area 621A and the sensor electrode area 621C, and the plurality of supports 623 are provided between the REF area 621B and the sensor electrode area 621C.

The folding area 621D is an area for folding the FPC 621 between the REF area 621A and the REF area 621B. The folding area 621E is an area for folding the FPC 621 between the REF area 621B and the sensor electrode area 621C.

The REF area 621A is an area corresponding to the REF layer 23 in the first embodiment and includes the REF layer 23. The REF area 621B is an area corresponding to the REF layer 24 in the first embodiment and includes the REF layer 24. The sensor electrode area 621C is an area corresponding to the sensor electrode layer 25 in the first embodiment and includes a plurality of sensing parts SE.

The supports 622 support the sensor electrode area 621C on the REF area 621A and separate the REF area 621A from the sensor electrode area 621C. The supports 623 support the REF area 621B on the sensor electrode area 621C and separate the sensor electrode area 621C from the REF area 621B.

The plurality of supports 622 are disposed in a row to be separated at predetermined intervals in the longitudinal direction of the sensor 620, and spaces 622A are provided between the supports 622 adjacent to each other. The sensing parts SE are provided on the spaces 622A. The plurality of supports 623 are disposed in a row to be separated at predetermined intervals in the longitudinal direction of the sensor 620, and spaces 623A are provided between the supports 622 adjacent to each other. The sensing parts SE are provided under the spaces 622B.

As materials of the supports 622 and 623, the same materials as that of the support 26A in the first embodiment can be exemplified.

### Effects

In the sensor 620 according to the sixth embodiment, the constituents correspond to the REF layer 23, the REF layer 24, and the sensor electrode layer 25 in the first embodiment can be configured by one FPC 621. Therefore, the number of parts can be reduced as compared with the sensor 20 according to the first embodiment.

### MODIFIED EXAMPLES

### Modified Example 1

In the sixth embodiment, the configuration in which the REF area 621A, the REF area 621B, and the sensor electrode area 621C are provided in one FPC has been described, but the configuration of the sensor 620 is not limited thereto. For example, the REF area 621A, the REF area 621B, and the sensor electrode area 621C may be provided in different FPCs.

### Modified Example 2

The sensor 620 may include the support base material 21 and the elastic layer 22 according to the first embodiment on the second surface S2 side, and the non-bonded areas AR may be provided between the support base material 21 and the elastic layer 22. Also, the sensor 620 may include the spring structure part 321 and the support base material 21 according to the fourth embodiment on the second surface S2 side. Further, the sensor 620 may include the support base material 521A according to the fifth embodiment on the second surface S2 side.

### EXAMPLES

Hereinafter, the present disclosure will be specifically described with reference to examples, but the present disclosure is not limited to these examples. Also, in the following examples, the parts corresponding to those of the above-described first to fourth embodiments will be denoted by and described with the same reference numerals.

In the following examples, the 25% compression load of urethane foam is a value measured in accordance with JIS K 6254. In addition, hardness of silicone rubber is a value measured in accordance with JIS K 6253.

The present example will be described in the following order.

i Review on structure that can take wide range of sensitivity

ii Review on inhibition of peak of sensitivity (1)

iii Review on inhibition of peak of sensitivity (2)

iv Review on deterioration inhibition of elastic layer

v Review on sensor including spring structure part instead of elastic layer

vi Review on configuration of spring structure part

<i Review on Structure that can Take Wide Range of Sensitivity>

### Example 1

By laminating each of the members shown below, a rectangular film-shaped sensor 20 having the configuration shown in FIG. 6B was produced.

REF layer 24: SUS layer with a thickness of 30 μm

Support 27A: Double-sided adhesive tape with a thickness of 100 μm

Sensor electrode layer 25: FPC with a thickness of 85.5 μm

Support 26A: Double-sided adhesive tape with a thickness of 100 μm

REF layer 23: SUS layer with a thickness of 30 μm

Elastic layer 22: Urethane foam (polyurethane foam) with a 25% compression load of 0.25 MPa and a thickness of 500 μm

Support base material 21: SUS layer with a thickness of 300 μm

### Example 2

The sensor 20 was produced in the same manner as in Example 1 except that the following elastic layer 22 was used.

Elastic layer 22: Urethane foam (polyurethane foam) with a 25% compression load of 0.066 MPa and a thickness of 1,000 μm (1 mm)

[Evaluation of Sensitivity]

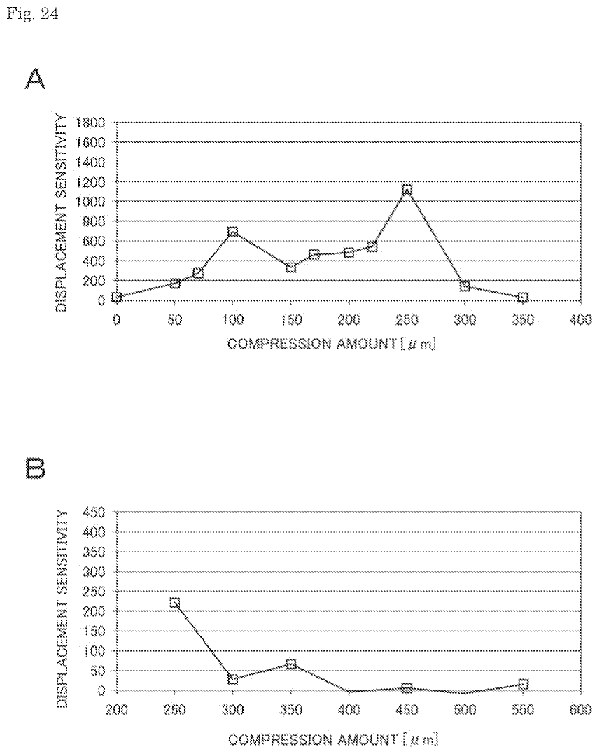

A sensor output (displacement sensitivity) corresponding to an amount of change in electrostatic capacitance was acquired when a thickness of the sensor 20 was changed by pressing on the sensing part SE using a silicone rubber key stroker of 06 mm. The results are shown in FIGS. 24A and 24B.

The following can be seen from the above evaluation results.

In the sensor 20 of Example 1 using the elastic layer 22 having the 25% compression load of 0.25 MPa, good sensitivity can be obtained in a wide range as compared with the sensor 20 of Example 2 using the elastic layer 22 having the 25% compression load of 0.066 MPa.

<ii Review on Inhibition of Peak of Sensitivity (1)>

### Example 3

The sensor 20 was produced in the same manner as in Example 1 except that the following were used as the elastic layer 22 and the REF layer 24.

REF layer 24: SUS layer with a thickness of 100 μm

Elastic layer 22: Silicone rubber with a hardness of A31 and a thickness of 500 μm

### Example 4

As shown in FIG. 11, the sensor 120 further including the elastic layer 121 and the base material 122 was produced. The following were used as the elastic layer 121 and the base material 122.

Base material 122: SUS layer with a thickness of 300 μm

Elastic layer 121: Urethane foam (polyurethane foam) with a 25% compression load of 0.007 MPa and a thickness of 500 μm

Also, as the members other than the elastic layer 121 and the base material 122, the same members as in Example 3 were used.

[Evaluation of Sensitivity]

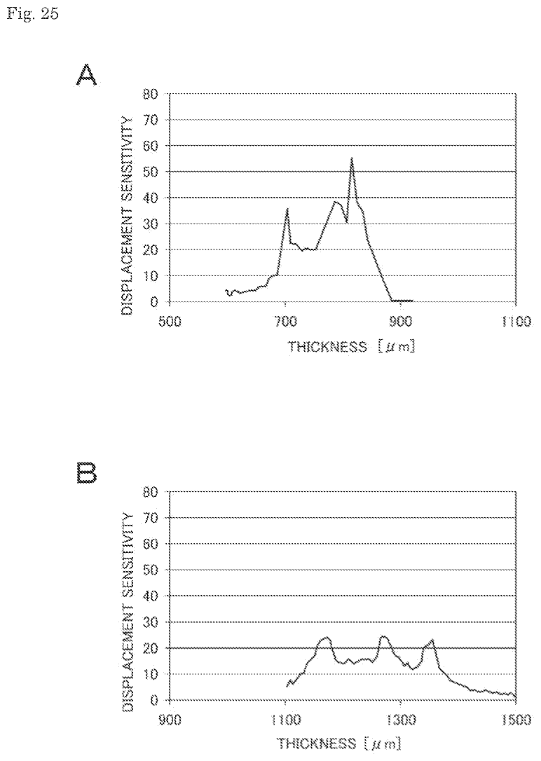

The sensitivity was evaluated in the same manner as in Example 1. The results are shown in FIGS. 25A and 25B.

From the above evaluation results, it can be seen that the peak of sensitivity can be inhibited by using two layers, the elastic layer 22 and the elastic layer 121, as the elastic layer.

<iii Review on Inhibition of Peak of Sensitivity (2)>

### Example 5

The sensor 20 was produced in the same manner as in Example 1 except that the following were used as the elastic layer 22 and the REF layer 24.

REF layer 24: SUS layer with a thickness of 100 μm

Elastic layer 22: Silicone rubber with a hardness of A31 and a thickness of 500 μm

### Example 6

As shown in FIG. 12, the sensor 220 in which the structure 26C is provided in each space 26B and the structure 27C is provided in each space 27B was produced. The following structures were used as the structures 26C and 27C.

Structure 26C: Laminate of a PET film 26D with a thickness of 10 μm and a double-sided adhesive tape 26E

Structure 27C: Laminate of a PET film 27D with a thickness of 10 μm and a double-sided adhesive tape 27E

Also, as the members other than the structure 26C and the structure 27C, the same members as in Example 5 were used.

### Example 7

The sensor was produced in the same manner as in Example 6 except that the structure 27C was provided only in the space 27B of the spaces 26B and 27B.

### Example 8

The sensor was produced in the same manner as in Example 6 except that the structure 26C was provided only in the space 26B of the spaces 26B and 27B.

[Evaluation of Sensitivity]

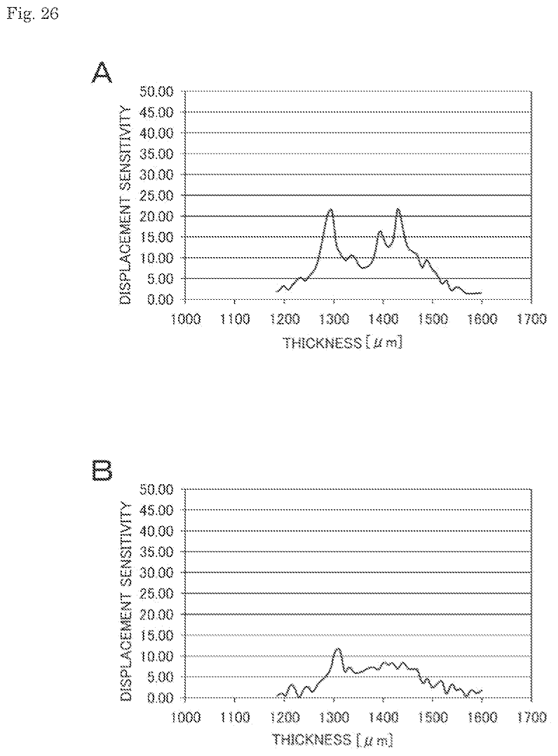

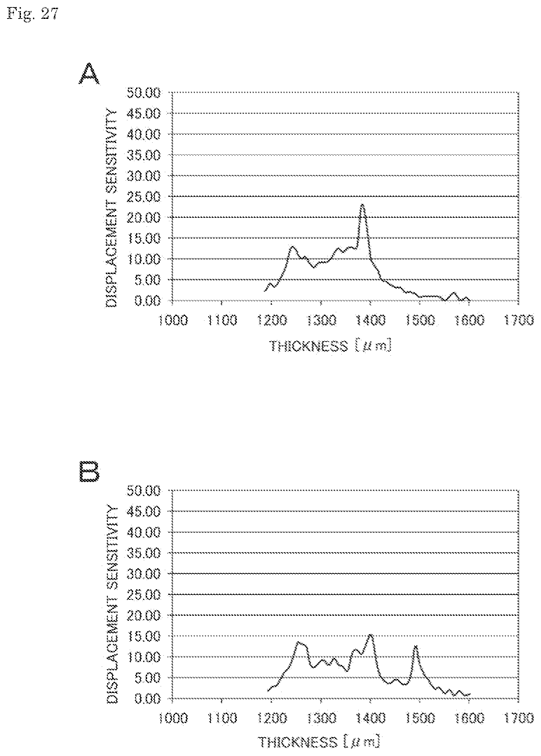

The sensitivity was evaluated in the same manner as in Example 1. The results are shown in FIGS. 26A, 26B, 27A and 27B.

The following can be seen from the above evaluation results.

In the sensor 20 of Example 5 in which neither the structure 26C nor the structure 27C is provided, two peaks appear in the sensitivity.

In the sensor 220 of Example 6 provided with both the structure 26C and the structure 27C, the above-mentioned two peaks are almost eliminated.

In the sensor of Example 7 provided with only the structure 27C, occurrence of a first peak among the above two peaks tends to be particularly inhibited.

In the sensor of Example 8 in which only the structure 26C is provided, occurrence of a second peak among the above two peaks tends to be particularly inhibited.

<iv Review on Deterioration Inhibition of Elastic Layer>

### Example 9

The sensor 20 was produced in the same manner as in Example 1 except that the following elastic layer 22 was used.

Elastic layer 22: Silicone rubber with a hardness of A31 and a thickness of 500 μm

### Example 10

The sensor 20 was produced in the same manner as in Example 1 except that the following elastic layer 22 was used.

Elastic layer 22: Silicone gel with a hardness of A15 and a thickness of 500 μm

[Evaluation of Sensitivity]

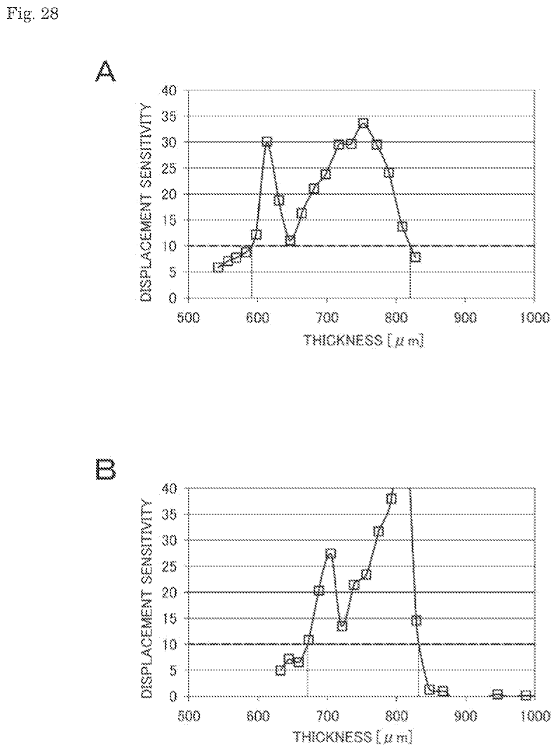

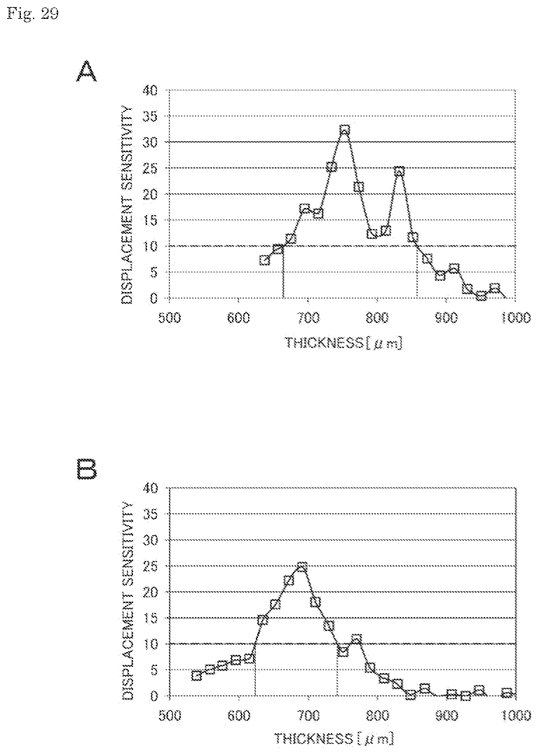

First, the sensitivity was evaluated in the same manner as in Example 1. The results are shown in FIGS. 28A and 29A. Next, after performing an acceleration test, the sensitivity was evaluated again in the same manner as in Example 1. The results are shown in FIGS. 28B and 29B.

The details of the acceleration test are shown below.

State of Sensor 20

In the same state as mounted on the housing 11, the most crushed state with the minimum width of the assumed tolerance

Environment

Temperature: 80° C. Humidity: Free time: 240 H

The following can be seen from the above evaluation results.

By using silicone rubber and silicone gel as the elastic layer 22, deterioration of the elastic layer 22 can be inhibited and long-term reliability can be improved.

In the case in which silicone rubber is used as the elastic layer 22, deterioration of the elastic layer 22 can be particularly inhibited.

<v Review on Sensor Including Spring Structure Part Instead of Elastic Layer>

### Example 11

As shown in FIG. 24, the sensor 320 having the spring structure part 321 instead of the elastic layer 22 was produced. The following members were used as each member of the spring structure part 321.

Support layer 324: Double-sided adhesive tape with a thickness of 100 μm

Spring member 323: SUS layer with a thickness of 100 μm

Structure 322: Double-sided adhesive tape with a thickness of 300 μm

Also, as the members other than the spring structure part 321, the same members as in Example 3 were used.

[Evaluation of Sensitivity]

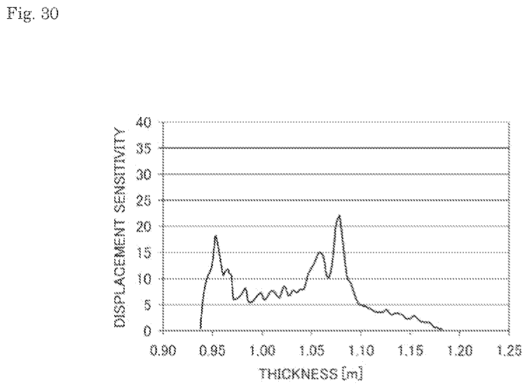

The sensitivity was evaluated in the same manner as in Example 1. The results are shown in FIG. 30.

From the above evaluation results, it can be seen that good detection sensitivity can be obtained with the sensor 320 including the spring structure part 321 as with the sensor 20 including the elastic layer 22.

<vi Review on Configuration of Spring Structure Part>

### Test Example 1

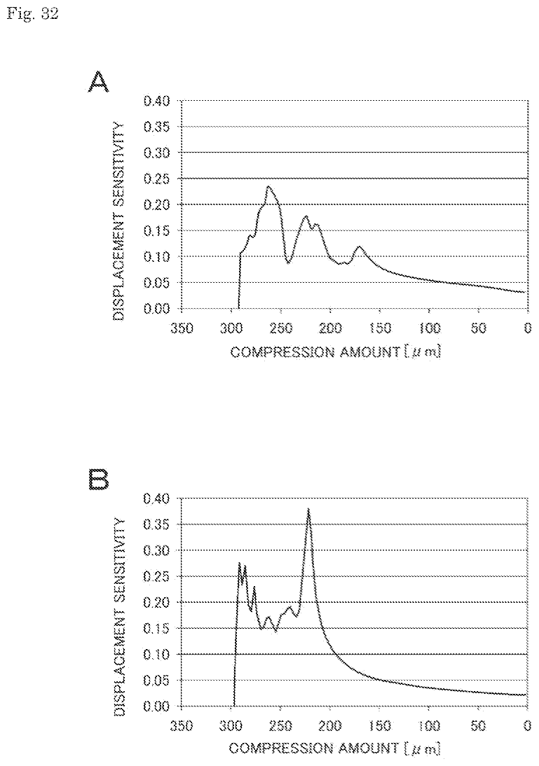

First, displacement distributions of the REF layers 23 and 24 when a load was applied on the sensing part SE of the sensor 320 were obtained using a stress simulation (finite element method). Subsequently, a change in electrostatic capacitance with respect to the displacements of the REF layers 23 and 24 when the REF layers 23 and 24 approached the sensing part SE was obtained using an electric field simulation (finite element method). Also, for a simulation model, the sensor 320 shown in FIG. 14 was used. Next, the results of the above stress simulation and electric field simulation are combined, and the sensor output (displacement sensitivity) corresponding to the amount of change in electrostatic capacitance was obtained at the time of pressing on the sensing part SE and changing the thickness of the sensor 320. The results are shown in FIG. 32A.

### Test Example 2

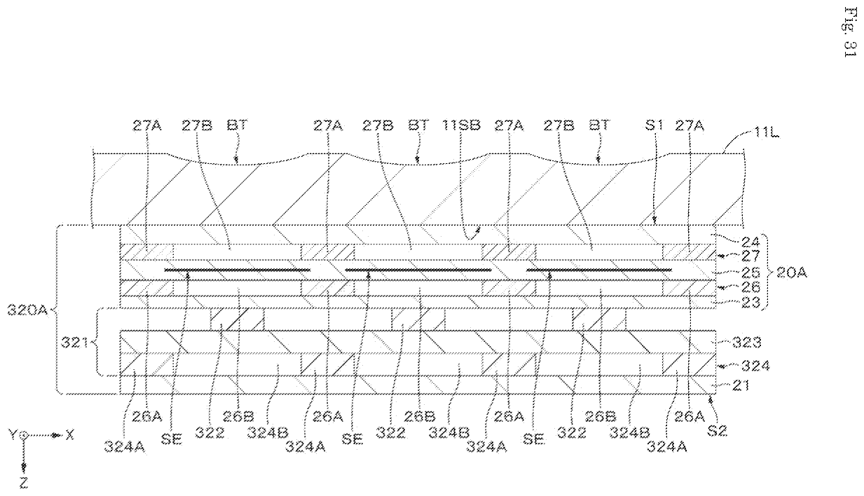

The sensor output (displacement sensitivity) was obtained in the same manner as in Test Example 1 except that the sensor 320A shown in FIG. 31 was used as the simulation model. The results are shown in FIG. 32B.

Also, the sensor 320A has the same configuration as the sensor 320 except that the structures 322 are provided between the spring member 323 and the REF layer 23, and the supports 324A are provided between the support base material 21 and the spring member 323.

The following can be seen from the results of the above simulation.

When arrangement positions of the supports 324A and the structures 322 are exchanged, the peak of sensitivity tends to increase. Therefore, from the viewpoint of inhibiting the peak of sensitivity, it is preferable that the supports 324A are provided between the spring member 323 and the REF layer 23, and the structures 322 are provided between the support base material 21 and the spring member 323.

Although the first to sixth embodiments of the present disclosure and modified examples thereof have been specifically described above, the present disclosure is not limited to the above-mentioned first to sixth embodiments and modified examples, and various modifications based on the technical idea of the present disclosure are possible.

For example, the configurations, methods, processes, shapes, materials, numerical values, and the like given in the above-mentioned first to sixth embodiments and modified examples are merely examples, and different configurations, methods, processes, shapes, materials, numerical values, and the like may be used, if necessary.

In addition, the configurations, methods, processes, shapes, materials, numerical values, and the like in the first to sixth embodiments and modified examples described above can be combined with each other without departing from the gist of the present disclosure.

Further, the present disclosure can also adopt the following configurations.

(1)

A sensor including;

a base material; a first elastic layer provided on the base material; and a sensor body which is provided on the first elastic layer and includes an electrostatic capacitive sensing part, wherein the base material and the first elastic layer are bonded such that an area corresponding to the sensing part becomes a non-bonded area.

(2)

The sensor according to (1), wherein the sensor body includes; a first reference electrode layer provided on the first elastic layer; a second reference electrode layer provided apart from the first reference electrode layer; a sensor electrode layer which is provided between the first reference electrode layer and the second reference electrode layer and includes the sensing part; a first support layer provided between the first reference electrode layer and the sensor electrode layer; and a second support layer provided between the second reference electrode layer and the sensor electrode layer.

(3)

The sensor according to (2), wherein the first elastic layer is configured to be pressed against the sensor body such that the first reference electrode layer can be pushed up toward the sensing part.

(4)

The sensor according to (2) or (3), wherein the first support layer has a first space between the first reference electrode layer and the sensing part, and the second support layer has a second space between the second reference electrode layer and the sensing part.

(5)

The sensor according to (4), wherein the sensor body further includes at least one of a first structure which is provided in the first space and is lower than a height of the first support layer and a second structure which is provided in the second space and is lower than a height of the second support layer.

(6)

The sensor according to (4) or (5), wherein the first elastic layer is configured to be pressed against the sensor body such that the first reference electrode layer can be pushed up into the first space.

(7)

The sensor according to any one of (1) to (6), further including a second elastic layer having a lower elastic modulus than the first elastic layer, wherein the base material is provided on the second elastic layer.

(8)

The sensor according to (7), wherein the base material has a higher elastic modulus than the first elastic layer and the second elastic layer.

(9)

The sensor according to any one of (1) to (8), wherein the first elastic layer contains a foamed resin, an elastomer or a gel.

(10)

A sensor including:

a structure; a spring member provided on the structure; a support layer provided on the spring member; and a sensor body which is provided on the support layer and includes an electrostatic capacitive sensing part, wherein the structure is provided at a position corresponding to the sensing part, and the support layer has a space at the position corresponding to the sensing part.

(11)

An input apparatus comprising:

an exterior body; and the sensor according to any one of (1) to (10), wherein the sensor is provided on an inner surface of the exterior body.

(12)

An electronic device comprising:

a housing; and the sensor according to any one of (1) to (10), wherein the sensor is provided on an inner surface of the housing.

(1)

A sensor including:

an elongated first reference electrode layer;

an elongated reference electrode member provided apart from the first reference electrode layer;

a sensor electrode layer which is provided between the first reference electrode layer and the reference electrode member and includes sensing parts;

a first support layer provided between the reference electrode member and the sensor electrode layer; and

a second support layer provided between the first reference electrode layer and the sensor electrode layer, wherein

both end parts of the reference electrode member have lower rigidity than the other parts.

(2)

The sensor according to (1), wherein thicknesses of both end parts of the reference electrode member are thinner than thicknesses of the other parts.

(3)

The sensor according to (1), wherein

the reference electrode member includes a support base material and a second reference electrode layer provided on the support base material, and both ends of the support base material are positioned inside both ends of the second reference electrode layer.

(4)

The sensor according to any one of (1) to (3), further including a plurality of pushers provided on the first reference electrode layer, wherein

the pushers are provided at positions corresponding to the sensing parts.

(5)

The sensor according to (4), further including two supports provided on the first reference electrode layer, wherein

the two supports are provided at both end parts of the first reference electrode layer, and

each support contains an adhesive on a top part thereof.

(6)

The sensor according to (5), wherein the pushers are higher than the supports.

(7)

The sensor according to any one of (1) to (6), wherein the first reference electrode layer, the second reference electrode layer, and the sensor electrode layer are configured of one flexible printed circuit board.

(8)

A sensor including:

an elongated support base material; and

an electrostatic capacitive sensor body which is provided on the support base material and has an elongated film shape, wherein

both ends of the support base material are positioned inside both ends of the sensor body.

(9)

An input apparatus including:

an exterior body; and

the sensor according to any one of (1) to (8), wherein

the sensor is provided on an inner surface of the exterior body.

(10)

An electronic device including:

a housing; and

the sensor according to any one of (1) to (8), wherein

the sensor is provided on an inner surface of the housing.

### REFERENCE SIGNS LIST

10 Electronic device
11 Housing
11M Bottom part
11N Wall part
11R, 11L Side wall part
11SA Outer surface
11SB Inner surface
12 Board
12A Controller IC
12B Main CPU
13 Front panel
13A Display apparatus
14 Groove part
20, 120, 220, 320 Sensor
20A Sensor body
21 Support base material
22 Elastic layer (first elastic layer)
22A, 22B Bonding layer
23 Reference electrode layer (first reference electrode layer)
24 Reference electrode layer (second reference electrode layer)
25 Sensor electrode layer
25A Base material
25B Pulse electrode
25B₁ Sub-electrode
25C Sense electrode
25C₁ Sub-electrode
25D Ground electrode
26 Support layer (first support layer)
26A Support
27 Support layer (second support layer)
27A Support
26B Space (first space)
26C Structure (first structure)
26D Polymer film
26E Adhesive layer
27B Space (second space)
27C Structure (second structure)
27D Polymer film
27E Adhesive layer
121 Elastic layer (second elastic layer)
121A, 121B Bonding layer
122 Base material
321 Spring structure part
322 Structure
323 Spring member
324 Support layer
324A Support
324B Space
40 Flexible printed circuit board
41 Connection part
42 Connector
AR Non-bonded area
BT Button
SE Sensing part

1. A sensor comprising:
a base material;
a first elastic layer provided on the base material; and
a sensor body which is provided on the first elastic layer and includes an electrostatic capacitive sensing part, wherein
the base material and the first elastic layer are bonded such that an area corresponding to the sensing part becomes a non-bonded area.

2. The sensor according to claim 1, wherein
the sensor body includes:
a first reference electrode layer provided on the first elastic layer;
a second reference electrode layer provided apart from the first reference electrode layer;
a sensor electrode layer which is provided between the first reference electrode layer and the second reference electrode layer and includes the sensing part;
a first support layer provided between the first reference electrode layer and the sensor electrode layer; and
a second support layer provided between the second reference electrode layer and the sensor electrode layer.

3. The sensor according to claim 2, wherein the first elastic layer is configured to be pressed against the sensor body such that the first reference electrode layer can be pushed up toward the sensing part.

4. The sensor according to claim 2, wherein the first support layer has a first space between the first reference electrode layer and the sensing part, and
the second support layer has a second space between the second reference electrode layer and the sensing part.

5. The sensor according to claim 4, wherein the sensor body further includes at least one of a first structure which is provided in the first space and is lower than a height of the first support layer and a second structure which is provided in the second space and is lower than a height of the second support layer.

6. The sensor according to claim 4, wherein the first elastic layer is configured to be pressed against the sensor body such that the first reference electrode layer can be pushed up into the first space.

7. The sensor according to claim 1, further comprising a second elastic layer having a lower elastic modulus than the first elastic layer, wherein
the base material is provided on the second elastic layer.

8. The sensor according to claim 7, wherein the base material has a higher elastic modulus than the first elastic layer and the second elastic layer.

9. The sensor according to claim 1, wherein the first elastic layer contains a foamed resin, an elastomer or a gel.

10. A sensor comprising:
a structure;
a spring member provided on the structure;
a support layer provided on the spring member; and
a sensor body which is provided on the support layer and includes an electrostatic capacitive sensing part, wherein
the structure is provided at a position corresponding to the sensing part, and
the support layer has a space at the position corresponding to the sensing part.

11. An input apparatus comprising:
an exterior body; and
the sensor according to claim 1, wherein
the sensor is provided on an inner surface of the exterior body.

12. An electronic device comprising:
a housing; and
the sensor according to claim 1, wherein
the sensor is provided on an inner surface of the housing.
